(19) United States
(12) Patent Application Publication
(10) Pub. No.: US 2001/0042028 A1
(43) Pub. Date: Nov. 15, 2001

(54) Method and system for eyeglass ordering on a network

(75) Inventor: Takehiko Yoshida, Higashiosaka-shi (JP)

Correspondence Address: Joseph R. Keating, Esq., Keating & Bennett LLP, Suite 312, 10400 Eaton Place, Fairfax, VA, 22030, US

(73) Assignee: Vision Optic Co., Ltd., Higashiosaka-shi (JP)

(21) Appl. No.: 09/750,369

(22) Filed: Dec. 28, 2000

(30) Foreign Application Priority Data
Apr. 7, 2000 (JP) 2000-107110

(51) Int. Cl. G06F 17/60

(52) U.S. Cl. 705/27; 705/26

(57) ABSTRACT

A system and method for ordering and purchasing eyeglasses remotely via a network includes a user access unit, an eyeglass ordering and marketing service center, and a network that connects therebetween. The network eyeglass ordering and marketing system includes an eyeglass frame selection unit for selecting eyeglass frames from among a plurality of eyeglass frames in response to user input, a display generator for creating and displaying information concerning eyeglass frames, a vision test unit for testing the vision of the network user, and an eyeglass lens selection unit for selecting lenses from among a plurality of eyeglass lenses in response to user input. The system also includes an eyeglass ordering and marketing processor wherein the frame selection unit, the vision test unit, and the lens selection unit carry out a vision test in response to the requirements of the user. Appropriate eyeglass frames and eyeglass lenses are determined which best fit the user. The user is provided with information concerning ordering and marketing and an eyeglass purchase contract is concluded with the user. The system also includes a display information creating unit for creating information concerning eyeglass frames in cooperation with or independently of the frame selection unit and/or the eyeglass ordering and marketing processor to transmit the eyeglass frame information to the user.

### BACKGROUND OF THE INVENTION

1. Field of the Invention

The present invention relates to an eyeglass ordering and marketing system and a method of ordering and buying eyeglasses via a network.

2. Description of the Prior Art

These days, to take a vision test with uncorrected eyes or corrected eyes, one has to visit an ophthalmologist or visit an eyeglass shop to have his or her vision tested with an optometer apparatus located at the office of the ophthalmologist or the eyeglass shop.

Recently, for example, virtual malls are provided on networks such as on the Internet. However, eyeglass shops provided in the virtual malls offer no system for ordering and marketing eyeglasses upon confirming the wearing conditions and characteristics of eyeglass frames.

When a customer does not want to spend the time required to visit an eyeglass shop, there is no system for remotely ordering and marketing eyeglasses through which one can obtain eyeglasses via the Internet or other network.

Suppose that one's vision has become worse with the eyeglasses or contact lenses currently in use as compared to before the current eyeglasses or contact lenses were used. In this case, he or she has to determine if it is necessary to buy new eyeglasses or contact lenses. Presently, there is no system for ordering and marketing eyeglasses which remotely provides a vision test for uncorrected or corrected eyes and which allows one to place an order for and buy eyeglasses based on the resulting test data.

### SUMMARY OF THE INVENTION

In order to overcome the problems described above, preferred embodiments of the present invention provide a system and method for allowing customers to place an order for and buy eyeglasses remotely via a network.

According to a first preferred embodiment of the present invention, an eyeglass ordering and marketing system includes a user interface for allowing purchaser users to access the system, an eyeglass ordering and marketing service center, and a network that connects therebetween. The network eyeglass ordering and marketing system includes an eyeglass frame selection unit for selecting eyeglass frames from among a plurality of eyeglass frames in response to user input, a display generation unit for creating display information concerning eyeglass frames, a vision test unit for testing the vision of the user, and an eyeglass lens selection unit for selecting lenses from among a plurality of eyeglass lenses in response to user input. The system also includes an eyeglass ordering and marketing processor wherein the frame selection unit, the vision test unit, and the lens selection unit carry out a vision test in response to the requirements of the purchaser sent from the purchaser user, appropriate eyeglass frames and eyeglass lenses are determined which best fit the vision of the user, the purchaser user is provided with information concerning ordering and marketing, and an eyeglass purchase contract is concluded with the purchaser. The eyeglass ordering and marketing system further includes a display information generation unit for creating information concerning eyeglass frames in cooperation with or independently of the frame selection unit and/or the eyeglass ordering and marketing processor to transmit the eyeglass frame information to the user.

A second preferred embodiment of the present invention provides a method for ordering and marketing eyeglasses for allowing users to order eyeglasses from an eyeglass ordering and marketing service center which is accessed by the user via a network. The method includes the steps of selecting eyeglass frames from among a plurality of eyeglass frames in response to user input, creating display information concerning eyeglass frames, testing the vision of the purchaser, and selecting eyeglass lenses from among a plurality of eyeglass lenses in response to user input. The method also includes the step of ordering and marketing eyeglasses wherein the steps of selecting frames, testing, and selecting lenses carry out a vision test in response to the requirements of the purchaser based on user input. Appropriate eyeglass frames and eyeglass lenses are determined which best fit the user's vision. The purchaser user is provided with information about ordering and marketing and an eyeglass purchase contract is concluded with the purchaser. The method further includes the step of creating display information wherein information about eyeglass frames is created in cooperation with or independently of the step of selecting frames and/or the step of ordering and marketing eyeglasses to transmit the eyeglass frame information to the purchaser user.

The above and other elements, characteristics, features and advantages of the present invention will be apparent from the following detailed description of preferred embodiments of the present invention with reference to the accompanying drawings.

### BRIEF DESCRIPTION OF THE DRAWINGS

FIG. 1 is a view illustrating an exemplary configuration of a network eyeglass ordering and marketing system according to a preferred embodiment of the present invention;

FIG. 2 is a view illustrating a first outline of the process flow of a network eyeglass ordering and marketing system;

FIG. 3 is a view illustrating a second outline of the process flow of a network eyeglass ordering and marketing system;

FIG. 4 is a view illustrating an outline of the process flow (step 2) of a network eyeglass ordering and marketing system for existing users;

FIG. 5 is a view illustrating an outline of the process flow (step 3) of a network eyeglass ordering and marketing system for unregistered users with a doctor's prescription;

FIG. 6 is a view illustrating an outline of the process flow (step 4) of a network eyeglass ordering and marketing system for unregistered users without a doctor's prescription;

FIG. 7 is a view illustrating an outline of the process flow (step 4′) of a network eyeglass ordering and marketing system for unregistered users without a doctor's prescription;

FIG. 8 is a view illustrating an outline of the process flow (step 5) of a network eyeglass ordering and marketing system for selecting ready-made presbyopic eyeglasses;

FIG. 9 is a view illustrating a lens selection reference database;

FIG. 10 is a view illustrating a lens database;

FIG. 11 is a view illustrating an exemplary configuration of a remote vision test system;

FIG. 12 is a view illustrating an exemplary configuration of a database including user information which is controlled by a database controller at a service center;

FIG. 13 is a view illustrating an exemplary configuration of a database including reference information for vision tests which is controlled by a database controller at a service center;

FIG. 14 is a view illustrating an exemplary configuration of a database including vision test information which is controlled by a database controller at a service center;

FIG. 15 is a view illustrating an exemplary configuration of a database including a vision test table which is controlled by a database controller at a service center;

FIG. 16 is a view illustrating an exemplary configuration of a database including nearsightedness information which is controlled by a database controller at a service center;

FIG. 17 is a view illustrating an exemplary configuration of a database including farsightedness information which is controlled by a database controller at a service center;

FIG. 18 is a view illustrating an exemplary configuration of a database including astigmatism information which is controlled by a database controller at a service center;

FIG. 19 is a view illustrating a screen for performing a vision test of uncorrected eyes of users;

FIG. 20 is a view illustrating a screen for displaying a vision test table to users of the system;

FIG. 21 is a view illustrating the result of a vision test;

FIG. 22 is a view illustrating an exemplary configuration of a virtual eyeglass wearing system;

FIG. 23 is a view illustrating a n exemplary configuration of a database including user information which is controlled by a database controller at a service center;

FIG. 24 is a view illustrating an example of data which is input by a frame selection information input unit at a service center;

FIG. 25 is a view illustrating an exemplary configuration of a database on the frame functional structure of each frame which is controlled by a database controller at a service center;

FIG. 26 is a view illustrating an exemplary configuration of a database including the frame ornamental structure of each frame which is controlled by a database controller at a service center;

FIG. 27 is a diagrammatic view illustrating a measuring method on a side of a face image;

FIG. 28 is a diagrammatic view illustrating a measuring method on the front of a face image; and

FIG. 29 is a diagrammatic view illustrating a method for adjusting frames.

### DETAILED DESCRIPTION OF THE PREFERRED EMBODIMENTS

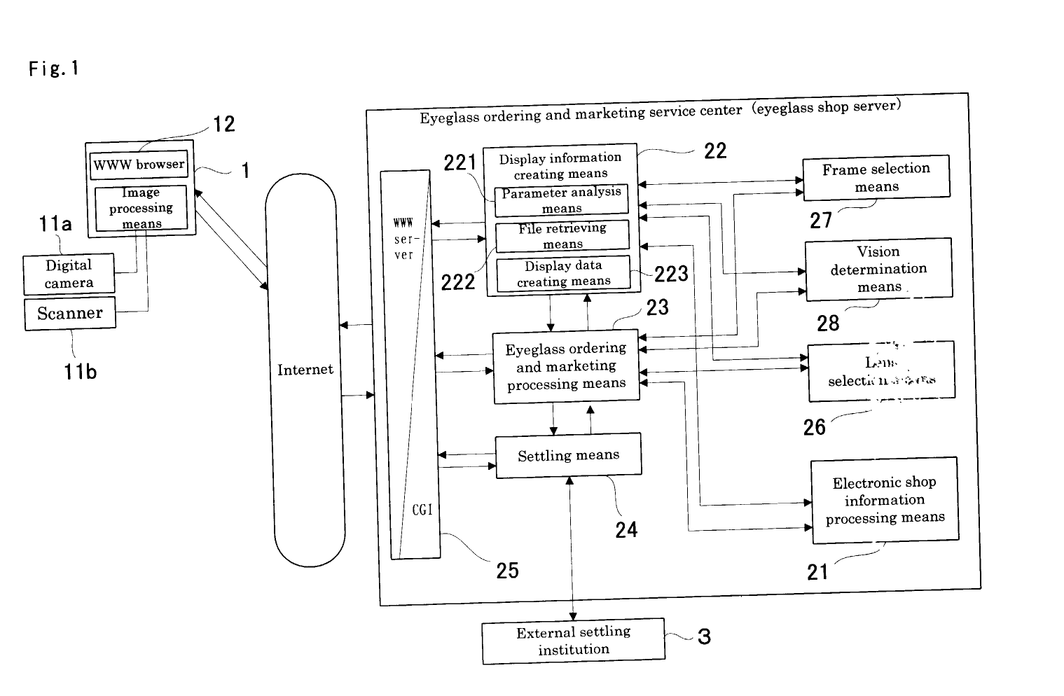

FIG. 1 is a view illustrating an exemplary configuration of a network eyeglass ordering and marketing system according to a preferred embodiment of the present invention.

As shown in FIG. 1, the network eyeglass ordering and marketing system includes hardware or software defining a user interface unit 1 and an eyeglass ordering and marketing service center 2. These components are operatively connected to each another via a network.

Incidentally, the following explanation is made on the precondition that the Internet is preferably used to connect the user interface unit 1 to the eyeglass ordering and marketing service center 2. However, other networks and data transmission systems may be used to connect and exchange information between the user interface unit 1 and the eyeglass ordering and marketing service center 2.

The network eyeglass ordering and marketing system is adapted to market custom-made magnifying eyeglasses to the vision or requests of purchasers, including the eyeglass ordering and marketing service center 2.

The electronic eyeglass ordering and marketing system comprises hardware and/or software defining the user interface unit 1, the eyeglass ordering and marketing service center 2, and an external settling institution 3. These components are operatively connected to each other via a network or suitable data transmission system.

Incidentally, the following explanation is made on the precondition that the Internet is preferably used to connect the user interface unit 1, the eyeglass ordering and marketing service center 2, and the external settling institution 3 to each other. However, other networks and data transmission systems may be used to connect and exchange information between the user interface unit 1, the eyeglass ordering and marketing service center 2 and the external settling institution.

The user interface unit 1 includes a terminal used by purchasers for placing an order for and obtaining their eyeglasses via a network, being realized, for example, with a personal computer. The user interface unit 1 includes an I/O unit 11 or an interface between a purchaser or a user and the eyeglass ordering and marketing service center 2. More specifically, the user interface unit 1 is realized with input devices such as a keyboard or a mouse as well as output devices such as a CRT display.

Incidentally, a keyboard is preferably used as an input device for inputting information such as text data. However, various types of input devices can be used, for example, pointing devices such as mice, track balls, or joysticks; touch panels, or switches, voice activated/recognition devices, and any other suitable data input device.

Furthermore, a digital camera 11a is preferably provided as an image information input device. However, any device such as television cameras, video cameras, or digital still camera may be used so long as it allows image information to be digitized for input. In addition, a hard disc and CD-ROM drive are prepared as a storage unit for storing images or other information, allowing image information, programs or the like stored in the CDs to be used. It is also possible to use devices for storage media such as DVDs, MOs, or memory units.

In addition, the personal computer according to this preferred embodiment is adapted to be connected to a computer network (network) or the Internet, so that image information, software, or any other information or data can be transmitted and received via the network.

Moreover, the user interface unit 1 preferably includes a WWW browser 12 as an interface to the server of the eyeglass ordering and marketing service center 2. When the user interface unit 1 includes a personal computer, the WWW browser 12 is realized as a program stored in the memory.

The eyeglass ordering and marketing service center 2 includes an electronic shop information processor 21, a display information creating unit 22, an eyeglass ordering and marketing processor 23, a settling unit 24, and a WWW server/CGI 25.

Specifically, the eyeglass ordering and marketing service center 2 includes information processing devices such as personal computers, workstations, and a server. The electronic shop information processor 21 is stored in a storage unit such as a magnetic or optical disk unit of the information processing devices. In practice, each of the processors mentioned above, i.e., the WWW server/CGI 25, the display information creating unit 22, the eyeglass ordering and marketing processor 23, and the settling unit 24 is stored in a program format in the memory of the information processing device.

The electronic shop information processor 21 defines product data such as eyeglass lenses and frames, which are dealt with in the eyeglass ordering and marketing service center 2, in a product definition division via an I/O unit. The product data defined here are stored in a product database as product data information.

In this preferred embodiment, the product data information includes the names of shelves on which products such as frames are exhibited, product numbers, product names, prices, product descriptions of eyeglass lenses, frames, and other relevant and suitable information. The product data information further includes text data such as product control information, and image data of products such as frames. The eyeglass ordering and marketing service center 2 also preferably includes an I/O unit which serves as an interface to creators of electronic catalogs. The I/O unit accepts the input of product information including text data such as names of product shelves, product items, and prices, which are required for product definition, or image data showing product shapes, from the creators of the catalogs. As order information on products purchased by purchasers, the eyeglass ordering and marketing service center 2 also outputs information which includes information about products such as product numbers or quantities, information on addressees of products, and information on payment such as names of external settling institutions, payment dates, or the amount of payment. The eyeglass ordering and marketing service center 2 can include an information-processing device such as a personal computer including I/O devices such as a keyboard, a mouse, a CRT display or any other data input device. In this case, the product definition division can be realized by a program stored for execution in the memory of such an information-processing device.

The electronic shop information processor 21 is provided with an electronic open shop information unit that includes a shop database, a product database, and a basket database. The shop database stores information for opening electronic shops and information for defining shop layouts to display product information. The product database stores product data information that has been defined. On the other hand, the basket database accumulates the information of a product that the user interface unit 1 has instructed to purchase. The electronic shop information processor 21 performs the function of storing transferred product data information into the product database.

The display information creating unit 22 creates display information such as electronic catalogs in response to a request from the user interface unit 1. The display information creating unit 22 includes a parameter analysis unit 221, a file retrieving unit 222, and a display data creating unit 223. The parameter analysis unit 221 analyzes vision test data, frame selection information, and the like, which are received from the user interface unit 1 via the WWW server/CGI 25, and extracts parameters included therein. Based on the parameters extracted by the parameter analysis unit 221, the file retrieving unit 222 retrieves data that has been registered and stored in each database by the electronic shop information processing unit 21. The display data creating unit 223 creates display data that can be displayed as WWW pages, based on the data retrieved by the file retrieving unit 222. Thus, the display data creating unit 223 performs a function as the so-called WWW page creator.

When a product to be purchased (such as an eyeglass lens or a frame) is selected via the user interface unit 1, the eyeglass ordering and marketing processor 23 receives a user ID and a product ID to be purchased from the display information creating unit 22. Based on this information, the eyeglass ordering and marketing processing unit 23 then obtains detailed information about the product to be purchased from the product database, and stores the product information in a user basket database corresponding to the user within the basket database. Subsequently, the eyeglass ordering and marketing processing unit 23 obtains a list of products to be purchased by the purchaser from the basket database, and then passes the list to the display information creating unit 22.

When the user interface unit 1 has decided to purchase product, the settling unit 24 receives the user ID from the display information creating unit 22 to retrieve product data information corresponding to the purchaser from the basket database. Then, based on the product information that has been retrieved, the settling unit 24 makes a request of the external settling institution 3 for settling processing. The settling unit 24 is informed of the completion of the settling processing by the external settling institution 3, and thereafter notifies the eyeglass ordering and marketing processor 23 and the electronic shop information processor 21 that an order acceptance processing has been completed. In order to notify the user interface unit 1 of the purchase processing, the settling unit 24 also prepares invoice data, on which to base the process, to send the invoice data to the display information creating unit 22.

The WWW server (World Wide Web)/CGI (Common Gateway Interface) 25 functions as an interface to the user interface unit 1 to receive display request information from the user interface unit 1 as well as transfer display data to the user interface unit 1.

Based on the request sent from the settling unit 24 of the eyeglass ordering and marketing service center 2, the external settling institution 3 performs a settling processing task for payment of the ordered eyeglass in place of the eyeglass ordering and marketing service center 2.

In addition, the outline of the operation of the user interface unit 1 and the eyeglass ordering and marketing service center 2 will be described below.

In the eyeglass ordering and marketing service center 2, the WWW server/CGI 25 receives eyeglass ordering page information that is sent from the user interface unit 1, and then activates the display information creating unit 22.

The display information creating unit 22 is activated to receive the eyeglass ordering page information from the WWW server/CGI 25, which then allows the parameter analysis unit 221 to analyze the information. The parameter analysis unit 221 outputs information as analytical results such as a shop ID for identifying an electronic shop to be displayed, a catalog template for determining the type of a background image for an electronic catalog, the product ID of a product to be displayed, and a user ID for identifying the purchaser. Based on the data output from the parameter analysis unit 221, the file retrieving unit 222 retrieves data in the shop database, product database, and basket database, the data being necessary for creating a display window of a homepage requested by the user interface unit 1 for display.

After the file retrieving unit 222 has retrieved the data, the process is transferred to the display data creating unit 223. The display data creating unit 223 first identifies the type of a request from the user interface unit 1. When the request from the user interface unit 1 is one other than “the determination of a product to be purchased” and “the purchase of a product”, the display data creating unit 223 creates data for display using the result retrieved by the file retrieving unit 222.

Suppose that the type of a request from the user interface unit 1 has been identified “the determination of a product to be purchased” in the step of identifying the type of a request from the user interface unit 1. That is, when the user has provided an instruction of “putting a selected product into a shopping basket” to instruct to reserve a product being displayed, the display data creating unit 223 activates the eyeglass ordering and marketing processor 23.

The eyeglass ordering and marketing processor 23 is activated to receive a user ID and the product ID of the product, which the user has instructed to purchase, from the display data creating unit 223. With this product ID as key information, the eyeglass ordering and marketing processor 23 receives detailed product data information about the corresponding product from the product database. Then, the product data information retrieved in foregoing step is stored in the user basket database of the user within the basket database, the user being identified by the user ID received from the display data creating unit 223. At this point, when no corresponding user basket database exists, a user basket database that corresponds to the user ID is created to store the product data information therein. Then, all pieces of the product data information of the products that the user has selected so far are retrieved from the user basket database and passed to the display data creating unit 223. In this case, the display data creating unit 223 creates a list of display information on the products that the user intends to purchase, based on the product data information received from the eyeglass ordering and marketing processor 23, and then sends the list of display information to the user interface unit 1. Based on the information displayed at this point, the user can check the products to be purchased or cancel part of or all the products to be purchased.

Suppose that the type of a request from the user interface unit 1 has been identified “the purchase of a product” in the step of identifying the type of a request from the user interface unit 1. In other words, when the user has provided an instruction of his or her decision concerning the purchase of the products that the user has selected so far, the display data creating unit 223 activates the settling unit 24 prior to the creation of display data.

The settling unit 24 is activated to receive a user ID from the display data creating unit 223. With the received user ID using as a key, the settling unit 24 retrieves the product data information of the purchased product in the user basket database of the user identified with the user ID in the basket database. Based on the resulting product data information, a request for settling processing is sent to the external settling institution 3. In response to the request, the external settling institution 3 performs a settling processing task in place of the eyeglass ordering and marketing service center 2, and then notifies the eyeglass ordering and marketing service center 2 of the completion of the settling processing when completed. Since the settling processing performed in the external settling institution 3 is the same as the conventional one, no detailed description is provided for the settling processing herein.

Upon the reception of a notification from the external settling institution 3 that the settling processing has been completed, the settling unit 24 forwards the information of the order received to the eyeglass ordering and marketing service center 2. The information concerning the order received includes information about the ordered product such as the product number and quantity of the product, information about the destination indicating the destination of the product, and the settling information such as the name of the external settling institution 3 and the date and amount of payment. In the eyeglass ordering and marketing service center 2, the information on the order received from the WWW server/CGI via an I/O unit is displayed. Then, the settling unit 24 creates invoice data for notifying of the completion of the settling processing and transmits the invoice data to the display data creating unit 223. The display data creating unit 223 uses the invoice data that has been received to create a display window for notifying of the completion of the settling processing and thus forwards the window to the user interface unit 1.

Now, the method for ordering and marketing eyeglasses by using a network eyeglass ordering and marketing system will be described below.

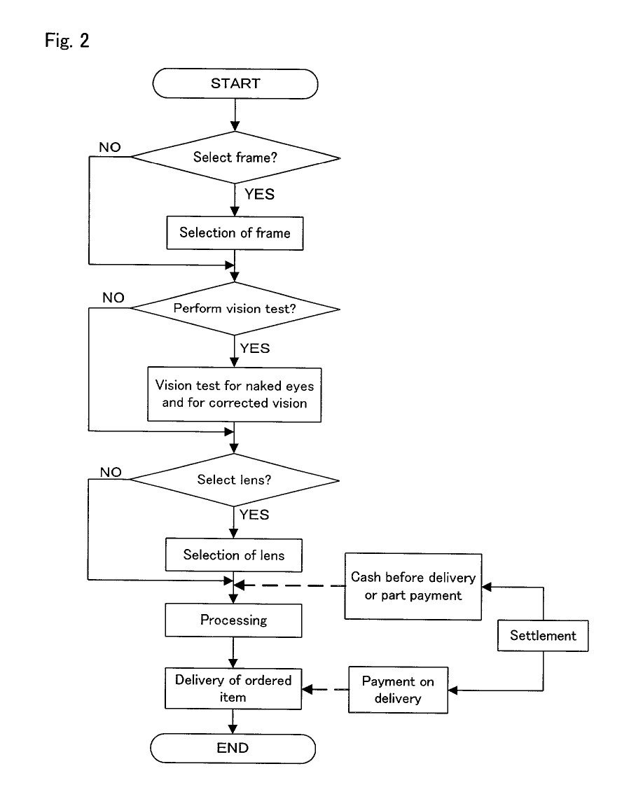

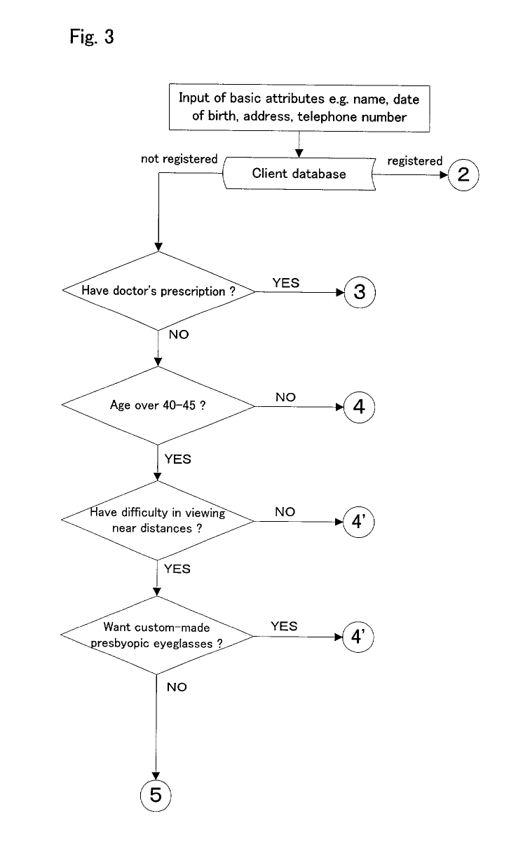

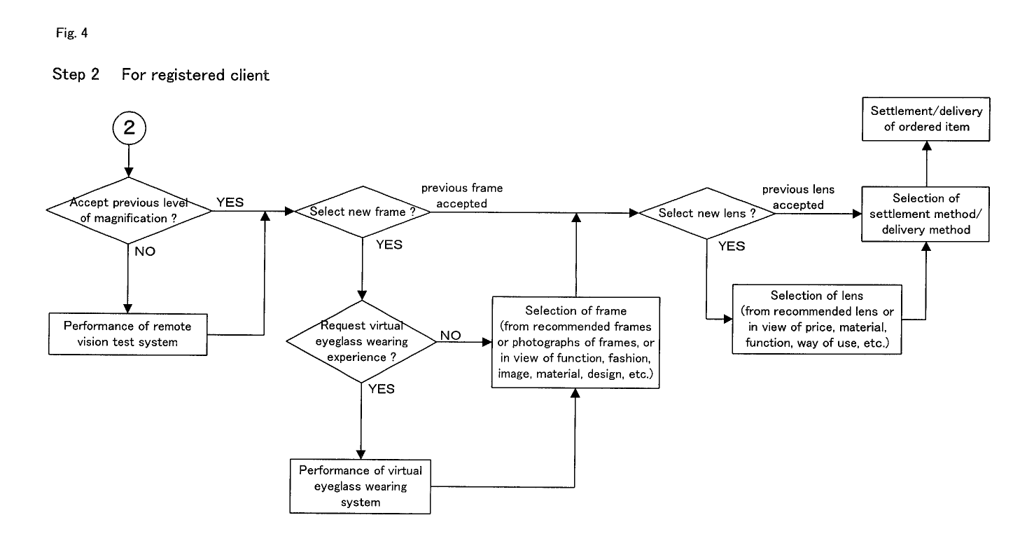

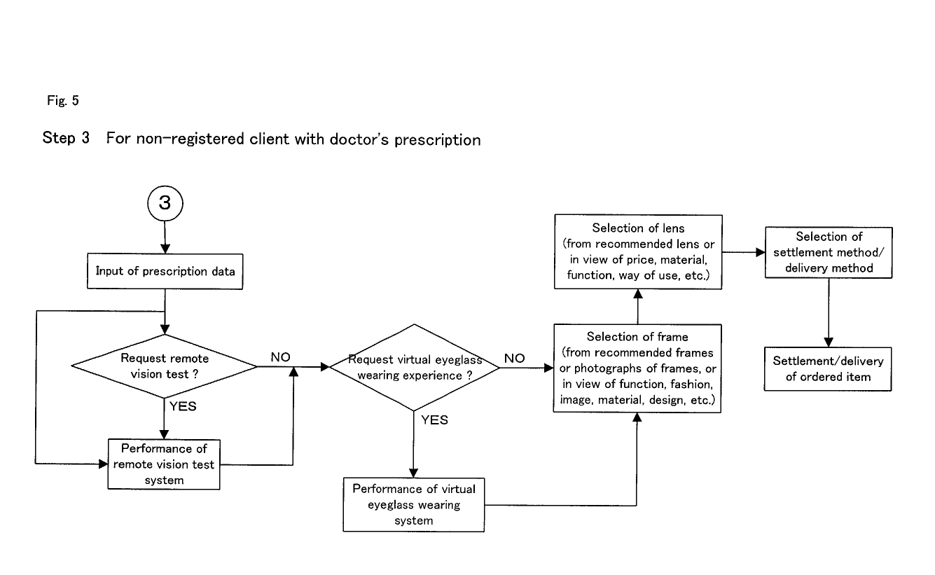

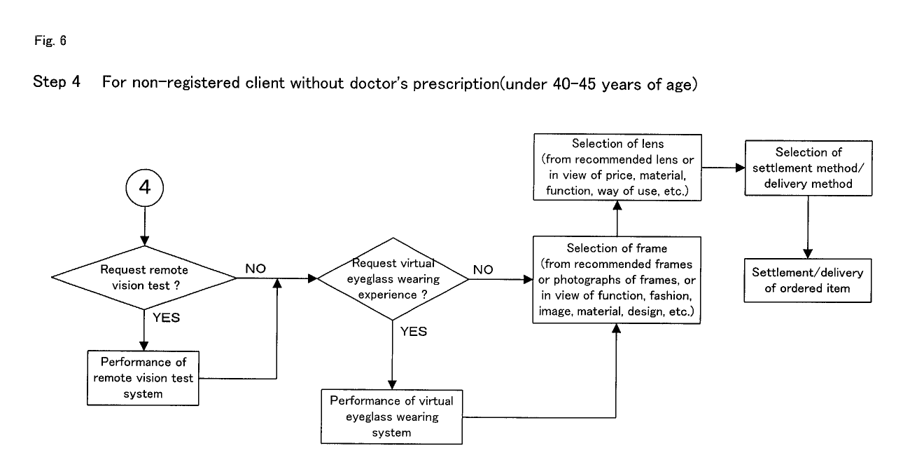

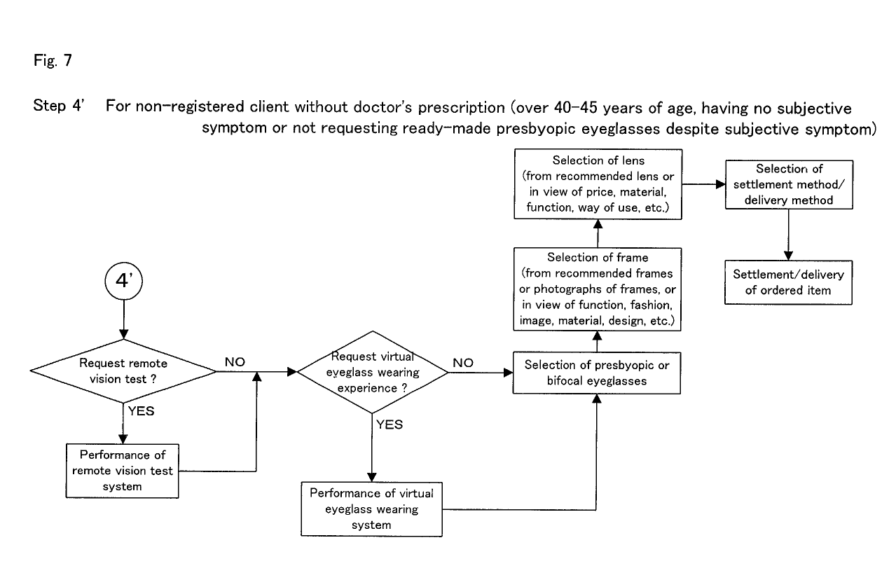

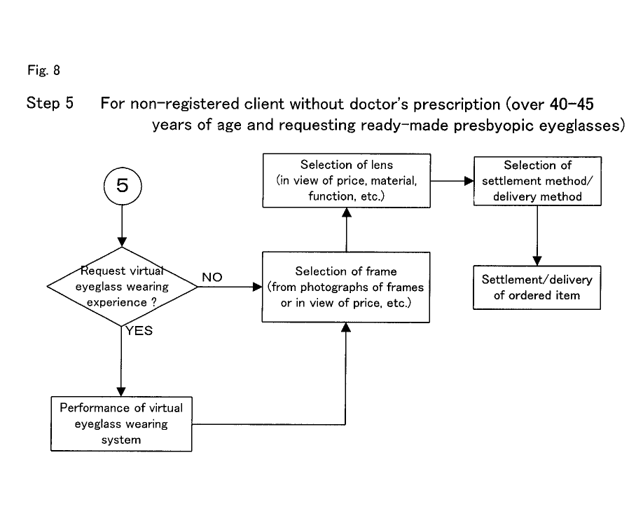

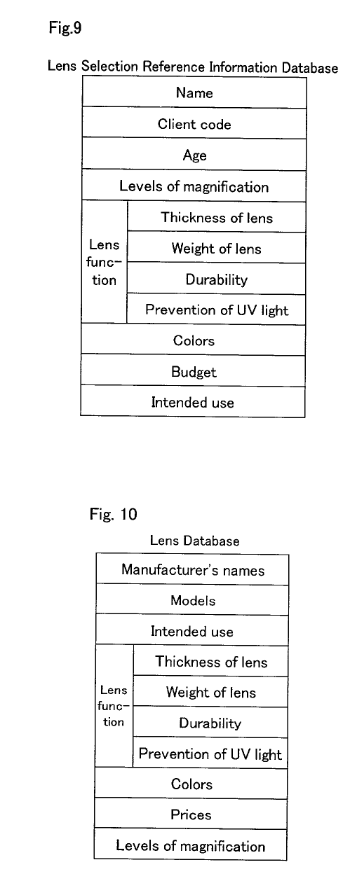

FIG. 2 is a view illustrating a (first) outline of the process flow of a network eyeglass ordering and marketing system. FIG. 3 is a view illustrating a (second) outline of the process flow of a network eyeglass ordering and marketing system. FIG. 4 is a view illustrating an outline of the process flow (step 2) of a network eyeglass ordering and marketing system for existing users. FIG. 5 is a view illustrating an outline of the process flow (step 3) of a network eyeglass ordering and marketing system for unregistered users with a doctor's prescription. FIG. 6 is a view illustrating an outline of the process flow (step 4) of a network eyeglass ordering and marketing system for unregistered users without a doctor's prescription. FIG. 7 is a view illustrating an outline of the process flow (step 4′) of a network eyeglass ordering and marketing system for unregistered users without a doctor's prescription. FIG. 8 is a view illustrating an outline of the process flow (step 5) of a network eyeglass ordering and marketing system for selecting ready-made presbyopic eyeglasses.

First, when the user interface unit 1 is connected to the eyeglass ordering and marketing service center 2, an ID code input window or a user authentication window is transmitted.

The user authentication window prompts the user to input user authentication information. The user interface unit 1 receives and displays the user authentication window, and allows user authentication information to be input and then sent to the eyeglass ordering and marketing service center 2.

The user authentication information includes a password, user ID and other suitable identifying information.

The eyeglass ordering and marketing service center 2 receives the user authentication information. Then, based on the information, the eyeglass ordering and marketing processor 23 or database controller retrieves data in the purchaser information database to perform authentication.

The eyeglass ordering and marketing service center 2 sends a basic attribute input window to the user interface unit 1 to allow the purchaser to input his or her basic attributes and personal information.

At the user interface unit 1, the purchaser inputs basic attributes such as his or her address, name, date of birth, and telephone number as well as the condition of eyes (e.g. having a difficulty in viewing near distances) and a request for eyeglasses in accordance with the basic attribute input window sent from the eyeglass ordering and marketing service center 2.

Based on the basic attributes of the purchaser sent by the user interface unit 1, the eyeglass ordering and marketing service center 2 retrieves his or her data in the user database which is controlled by the database controller to check if the purchaser has been registered as a user therein.

When it has been determined from the result of the retrieval that the purchaser is a registered user, the process proceeds to step 2 shown in FIG. 4, in which vision test data controlled in the eyeglass ordering and marketing service center 2 is retrieved.

Based on the vision test data and frame and lens information data, which are controlled in the user database (the basket database), an inquiry window is sent to the user interface unit 1 to check if new eyeglasses may be made according to the previous data of the purchaser.

In a case where the same frame and lenses as the previous ones can be accepted, the user interface unit 1 allows the purchaser to click “the same frame as the previous one is acceptable” on the inquiry window, which is then sent from the user interface unit 1 to the eyeglass ordering and marketing service center 2.

On the other hand, if the purchaser desires to have new frame and/or new lens, the process proceeds to a selection step and/or vision test step and/or lens selection step, which are described below.

In addition, if the purchaser has a doctor's prescription, the process proceeds to a prescription service step.

On the step selection window sent from the eyeglass ordering and marketing service center 2, the purchaser clicks “the frame selection step”, “the vision test step”, and “the lens selection step” to send the user's intention from the user to the eyeglass ordering and marketing service center 2.

After the lens selection criteria has been made clear in the vision test step or prescription service step, the process proceeds to the lens selection step.

In the eyeglass ordering and marketing service center 2, the user is retrieved in the user database or the like according to the basic attributes or the like which are input by the user via the basic attribute input window. If it has been determined that the purchaser is not a registered user, an inquiry window for checking if the purchaser has a doctor's prescription is sent from the eyeglass ordering and marketing service center 2 to the user interface unit 1.

On the prescription confirmation window sent to the user interface unit 1 for checking if the purchaser has a doctor's prescription, the purchaser clicks “YES” if the purchaser has a doctor's prescription or “NO” if the purchaser does not.

If the purchaser has the doctor's prescription, that is, if “YES” has been clicked, the process proceeds to step 3 shown in FIG. 5, in which an inquiry window is sent from the eyeglass ordering and marketing service center 2 to the user interface unit 1 to check if the purchaser is going to send the prescription by reading the prescription with a scanner or to input the text data of the prescription.

On the prescription data input window sent from the eyeglass ordering and marketing service center 2, the purchaser may input data based relating to his or her prescription. Alternatively, the purchaser may click a box section for reading with a scanner and sending the prescription to send the scanned image data to the eyeglass ordering and marketing service center 2.

Then, the eyeglass ordering and marketing service center 2 sends the data sequentially to the user interface unit 1 to allow the process to proceed to the frame selection step and/or the lens selection step.

If the purchase has no prescription prepared by an ophthalmologist or the purchaser has clicked “NO”, the eyeglass ordering and marketing service center 2 sends an inquiry window for checking if the purchaser is over 40-45 years of age.

If the purchaser is over 40-45 years of age and “YES” is clicked, the eyeglass ordering and marketing service center 2 further sends an inquiry window to the user interface unit 1 to check if the purchaser has difficulty in viewing near distances.

If the user is aware of difficulty in viewing near distances and clicks “YES”, the eyeglass ordering and marketing service center 2 judges that the user has presbyopia and then sends to the user interface unit 1 an inquiry window for checking if the purchaser desires to order presbyopic eyeglasses.

If the purchaser desires to buy custom-made eyeglasses and clicks “YES”, the process proceeds to step 4′ shown in FIG. 7. Then, the eyeglass ordering and marketing service center 2 sends the data sequentially to the user interface unit 1 to allow the process to proceed to the frame and lens selection steps.

On the other hand, if the purchaser has no subjective symptom of having difficulty in viewing near distances and clicks “NO”, the process proceeds to the step 4′ shown in FIG. 7. In this step, the eyeglass ordering and marketing service center 2 sends the data sequentially to the user interface unit 1 to allow the process to proceed to the frame and lens selection steps. Judging this case from the viewpoint of age, the purchaser seems to have presbyopia and thus has to go through an increased number of steps to select either presbyopic or bifocal eyeglasses.

On the other hand, if the purchaser does not desire to order custom-made presbyopic eyeglasses but desires to order ready-made presbyopic eyeglasses and clicks “NO”, information indicating that ready-made eyeglasses are to be ordered is sent to the eyeglass ordering and marketing service center 2.

The eyeglass ordering and marketing service center 2 determines the lens number that can be judged from the purchaser's age. Then, the process proceeds to a ready-made presbyopic eyeglass ordering system (step 5 in FIG. 8) for readily providing presbyopic eyeglasses.

If the purchaser is not over 40-45 years of age and clicks “NO”, the process proceeds to step 4 shown in FIG. 6, in which the process proceeds from the frame selection step and/or the vision test step to the lens selection step in the eyeglass ordering and marketing service center 2.

Subsequently, the lens selection step will be described below.

Suppose that the user has determined that the latest vision data can be used and clicks “the selection of lenses according to the latest vision data”. Moreover, suppose that the user has alternatively determined that his or her lenses may be prepared according to the doctor's prescription and clicks “the selection of lenses according to the doctor's prescription”. Furthermore, suppose that the user has alternatively determined that ready-made presbyopic eyeglasses may be used according to his or her age and clicks “the ready-made presbyopic eyeglasses may be employed”. In these cases, the lens selection unit 26 allows the user to select lenses according to the respective data.

On the other hand, suppose that the user desires to take a remote vision test via the Internet even when the latest vision data or the doctor's prescription is available. In this case, a vision determination unit 28 instructs the process to proceed to a remote vision test step that makes use of a remote vision test system.

Now, the remote vision test system and the method therefor will be described.

FIG. 11 is a view illustrating an exemplary configuration of the remote vision test system.

As shown in FIG. 11, the remote vision test system includes hardware and or software such as a user interface unit 1001 and an electronic service center 1002, which are operatively connected to each other via a network or other suitable data transmission system.

Incidentally, the following explanations will be made on the precondition that the Internet is preferably used as the network to connect the user interface unit 1001 to the electronic service center 1002.

The remote vision test system extracts vision test data such as the level of nearsightedness, farsightedness, and a stigmatism, based on reference data input from the user interface unit 1001 for testing vision. The remote vision test system also includes an output device for outputting vision test results containing the extracted data and includes the electronic service center 1002.

The electronic service center 1002 includes a vision test server, a user information registration units 1003, a vision test information input unit 1004, a database controller 1005, an image processor 1006, an audio processor 1007, a vision data creation unit 1008, and a WWW (World Wide Web) server 1009.

Specifically, the electronic service center 1002 includes information processing devices including personal computers, workstations, a server and other suitable devices.

In practice, the user information registration unit 1003, the vision test information input unit 1004, the database control unit 1005, the image processing unit 1006,the audio processing unit 1007, the vision data creation unit 1008, and the WWW server 1009 are each stored as a program in the memories of the information processing devices to be executed.

A database controlled by the database controller 1005 is stored in a storage unit such as a magnetic or an optical disk unit.

The electronic service center 1002 is connected to the user interface unit 1001 via a wide area computer network (the Internet).

The database controller 1005 controls information that is prepared by the electronic service center 1002 after collected from the user interface unit 1001 by the user information registration unit 1003, the vision test information input unit 1004, the image processor 1006, and the audio processor 1007. The information is controlled and organized into a user information database, a reference database for testing vision, a vision test database, a vision table database, a nearsightedness information database, a farsightedness information database, and an astigmatism information database. The database controller 1005 also performs functions such as for browsing information stored in a memory unit as the user information database, the reference database for testing vision, the vision test database, the vision table database, the nearsightedness information database, the farsightedness information database, and the astigmatism information database.

In addition, the database controller 1005 has an extraction unit for extracting data according to given conditions and a transmission unit for sending certain information to the user interface unit 1001.

The user information registration unit 1003 collects data concerning users or users desiring to take vision tests to register and control the data in the user information database. The data includes, for example, basic attributes such as addresses, names, dates of birth, telephone numbers, eye conditions (e.g., difficulty in viewing near distances), requests for eyeglasses, and data for identifying users such as user identifications (IDs), user passwords, and user codes.

In addition, user data necessary for identifying and sending messages to users such as facsimile numbers, e-mail addresses, and URLs is registered as well as data concerning computer environments.

The vision test information input unit 1004 determines and registers vision levels, based on data which is sent from user interface unit and includes reference for carrying out vision test.

The vision test information input unit 1004 also registers and controls each piece of data in the reference database for carrying out vision tests.

The image processor 1006 allows a scanner or other suitable optical device provided for (or connected to) the electronic service center 1002 to read the Landolt rings of a vision test table and as well the database controller 1005 to register and control the rings as a vision table database. In addition, the image processor 1006 transmits data to the user interface unit 1001 and displays the Landolt rings of the vision test table, which are registered and controlled in the vision table database.

The audio processor 1007 sends voice messages to users according to the window sent to the user interface unit 1001, and identifies the voice sent from the user interface unit 1001 to register and control the voice as data.

Based on the vision test references input at the user interface unit 1001, the vision data creation unit 1008 retrieves vision test data such as levels of nearsightedness, farsightedness, and astigmatism, and then creates vision test results including the retrieved data.

The WWW server 1009 has a WWW server device for building homepages that are used as an interface to allow the user interface unit 1001 to have access to the database controller 1005 and other elements of the electronic service center 1002.

The WWW server 1009 has a user authentication unit to verify using a password and an identification (ID) if users who request to be registered to and browse databases controlled by the database controller 1005 are authorized ones.

The user interface unit 1001 includes terminals used by users to apply for vision tests, the terminals being realized, for example, with personal computers or other suitable devices.

The user interface unit 1001 includes an I/O unit or an interface to a user or purchaser, and more specifically, may include input devices such as a keyboard and mouse as well as output devices such as a CRT display.

The user interface unit 1001 includes access devices such as a WWW browser as an interface for exchanging various data with the WWW server 1009 of the electronic service center 1002. In the case where the user interface 1001 includes a personal computer, the WWW browser is realized as a program to be stored in the memory thereof.

Now, such a case will be explained in which this system is realized by making use of homepages or the like on a network such as the Internet (a wide area computer network).

First, the electronic service center 1002 uploads a homepage on the Internet with the WWW server 1009.

With an access device such as a WWW browser of the user interface device 1001 that is connected to a wide area computer network, users access the user information registration unit 1003, which functions as an interface the homepage of the electronic service center 1002, to send a request for vision tests.

The electronic service center 1002 allows the user authentication unit of the WWW server 1009 to verify that the user is an authorized registered member according to authentication information of the user's password and/or identification (ID). After the verification, the user information registration unit 1003 of the electronic service center 1002 writes in the user information database and controls the information that the user has sent for registration via the wide area computer network.

When it has been determined that the user is accessing the vision test system for the first time, a basic attribute input window is sent to the user interface unit 1001. On the basic attribute input window, the user inputs basic attributes such as his or her address, name, date of birth, telephone number as well as eye conditions (difficulty in viewing near distances) requests for eyeglasses and other relevant information. Thus, the user interface unit 1001 allows the user to input necessary items, which are then sent to the electronic service center 1002.

In addition, the user also registers his or her password and/or member identification (ID) and other identifying information. Then, the user information registration unit 1003 writes the information on the user into the user information database via the wide area computer network and controls the information thus written therein.

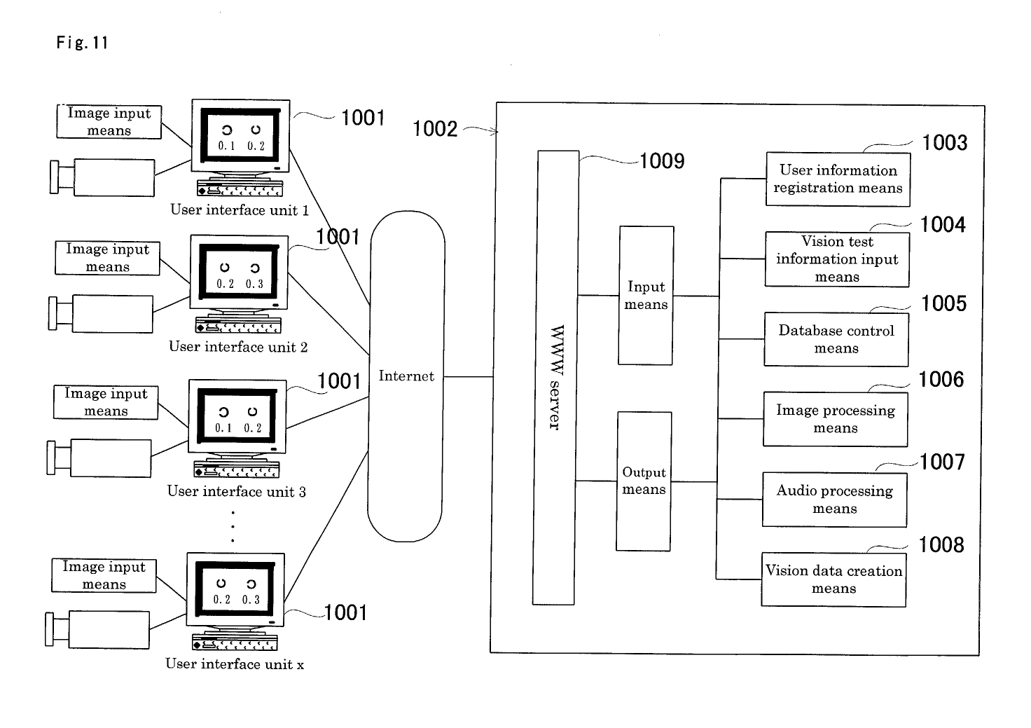

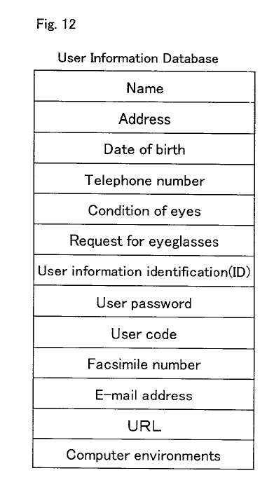

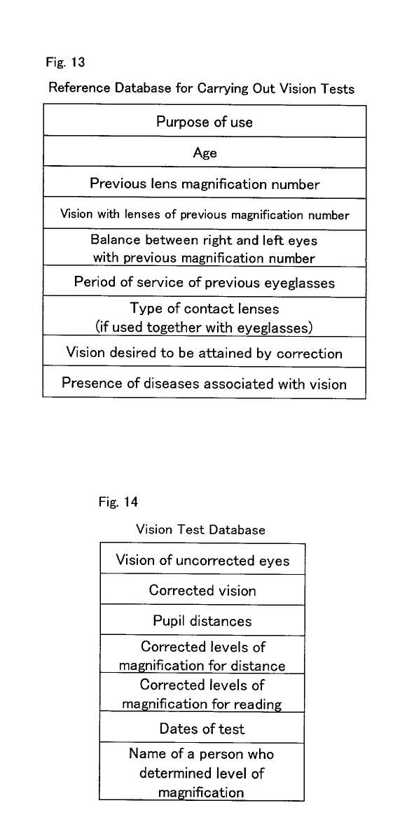

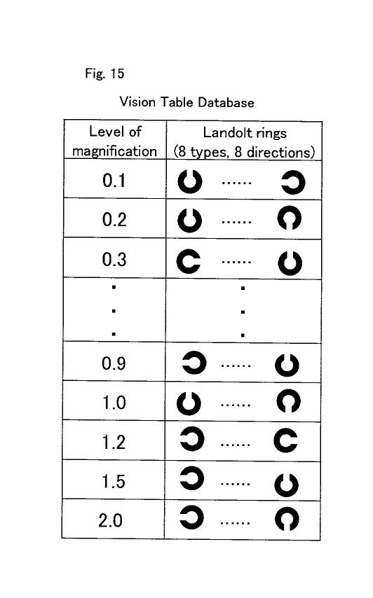

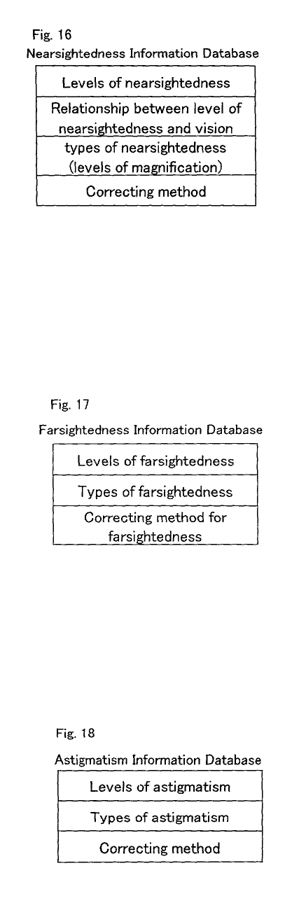

FIGS. 12-18 illustrate an exemplary configuration of each database that is controlled by the database controller 1005 at the electronic service center 1002.

For example, as shown in FIG. 12, the user information database stores user information which is used as information for identifying users and includes basic attributes such as user codes, user identifications (IDs), user passwords, addresses, names, dates of birth, and telephone numbers.

The user information includes the data that is input in the user information registration window sent to the user interface unit 1001 and that is registered by the user information registration unit 1003.

Incidentally, it is not always necessary to register data of all items.

User information identifications (IDs) and passwords may be determined at the service center according to the user information acquired off-line or may be automatically given at the time of an initial access of users.

Data stored in the reference database for carrying out vision tests includes the purpose of use, age, previous lens magnification number, vision with lenses of the previous magnification number, balance between the right and left eyes with lenses of the previous magnification number, the period of service of the previous eyeglasses, the type of contact lenses (if used together with the eyeglasses), vision desired to be attained by correction, the presence of diseases associated with vision and other relevant information.

The vision test database stores data such as vision of uncorrected eyes, corrected vision, pupil distances, corrected levels of magnification for distance, corrected levels of magnification for reading, dates of test, and the name of a person who determines the level of magnification.

The vision table database stores data indicating the relationship between the levels of magnification and the Landolt rings.

In the nearsightedness information database, registered and controlled are the levels of nearsightedness, the relationship between the level of nearsightedness and vision, types of nearsightedness (levels of magnification), and correcting method therefor. Incidentally, the term “nearsightedness” is used for the eye that causes parallel beams of light incident to the eye with no adjustment made therefor to focus at a point in front of the retina (finite far point in front of the retina).

The level of nearsightedness is expressed by the reciprocal of a far point distance (e.g., for a far point distance=50 cm, the level is equal to 1/0.5=2D).

The relationship between the level of nearsightedness and vision is as follows:

TABLE 1

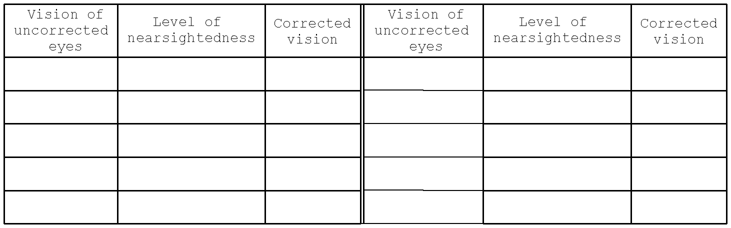

The types of nearsightedness (levels of magnification) are as follows:

minor nearsightedness (−4D), moderate nearsightedness (−4D to −7D), severe nearsightedness (−7D to −10D), and very severe nearsightedness (−10D or over).

The correcting method for nearsightedness is to wear an appropriate concave lens.

In the farsightedness information database, levels of farsightedness, types of farsightedness, and correcting method for farsightedness are registered and controlled. Incidentally, the term “farsightedness” is used for the eye that causes parallel beams of light incident to the eye with no adjustment made therefor to focus at a point behind the retina (finite far point behind the retina).

The level of farsightedness is expressed by the reciprocal of a far point distance (e.g., for a far point distance=50 cm, the level is equal to 1/0.5=2D).

The type of farsightedness is expressed by its level of magnification as follows:

minor farsightedness (+4D), moderate farsightedness (+4D to +7D), and severe farsightedness (+7D), the correction for which is to wear an appropriate convex lens.

In the astigmatism information database, levels of astigmatism, types of astigmatism, and correcting method for astigmatism are registered and controlled. Incidentally, the term “astigmatism” is used for the eye that causes parallel beams of light incident to the eye with no adjustment made therefor to focus at no point.

The types of astigmatism are as follows:

Regular astigmatism (Irregularity on the refraction surfaces is symmetrical.)

Irregular astigmatism (No image is formed due to different curvatures in the same meridian of the eye.)

Correcting methods for astigmatism are as follows:

Simple astigmatism (Wear an appropriate cylindrical lens.)

Compound astigmatism (Wear a cylindrical lens and a spherical lens in combination.)

Irregular astigmatism (Wear a contact lens.)

Now, a method for carrying out a vision test by the remote vision test system will be described below.

To begin with, the method for testing the vision of uncorrected eyes is described.

First, the user interface unit 1001 is connected to the service center 1002 to allow an ID code input window or a user authentication window to be transmitted. The user authentication window is to urge the user to input user authentication information. The user interface unit 1001 receives and displays the user authentication window, and then the user inputs user authentication information, which is in turn sent to the electronic service center 1002.

The user authentication information includes a password, user ID and other identifying information.

The electronic service center 1002 receives the user authentication information, based on which the database controller 1005 and the user information registration unit 1003 retrieve in the user information database to verify the user.

In the service center 1002, the database controller 1005 transmits a service menu window or a user member top page to the user interface unit 1001.

The user interface unit 1001 in turn receives and displays the service menu.

Then, on the service menu window, the user clicks “vision test for uncorrected eyes” for testing the vision of uncorrected eyes.

Now, an outline of the method for testing the vision of uncorrected eyes is described.

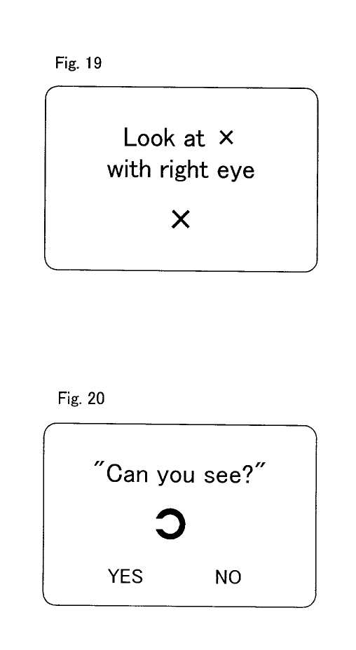

(1) The user covers one eye with a hand to see the uncorrected eye vision test window (FIG. 19) with the other eye. On the uncorrected eye vision test window (FIG. 19), there is provided a point to see with one eye.

(2) The user makes his or her neck stationary to maintain the same distance from the user to the uncorrected eye vision test window (FIG. 19). For example, in order to keep the face stationary, the user holds the neck on the hand palms with the elbows placed on a desk.

Then, in order to maintain the distance from the user to the uncorrected eye vision test window (FIG. 19), the user places one end of a 30-cm ruler on the window to set the distance to approximately 30 cm.

(3) The electronic service center 1002 allows the vision test information input unit 1004 to display a Landolt ring 1.0 of the vision test table at the point “X” on the window.

The electronic service center 1002 judges the distance from the user to the uncorrected eye vision test window (FIG. 19) using the vision test information input unit 1004, and displays a vision test table that corresponds to the vision 1.0.

(4) The user watches the Landolt ring of the vision test table (FIG. 20) with one eye.

(5) The electronic service center 1002 allows the vision test information input unit 1004 to display a question for the user on the window or the audio processor 1007 to present by voice the question, “Can you see the open side of the ring?”

(6) If the user can see it, the user clicks “YES” with a mouse (or responds by voice). In addition, the vision test information input unit 1004 of the electronic service center 1002 sends an interactive diagnosis window to the user interface unit 1001. A question “which side is open?” is displayed on the interactive diagnosis window to allow the user to click the mouse to choose (or answer by voice) the open side of the Landolt ring from the eight directions, that is, “up, down, left, right, upper left, lower left, upper right, and lower right directions”. If the chosen direction is correct, a vision test table of a level of magnification 1.2 is displayed and then the same process is repeated.

(7) If the user cannot see the ring or has chosen a wrong direction of the opening, the electronic service center 1002 displays a vision test table lower in level of magnification than the previous one to the user interface unit 1001 and then the same process is repeated.

(8) The electronic service center 1002 determines a correct level of magnification immediately before two consecutive errors as the uncorrected eye vision.

(9) Then, the same process is carried out on the other eye.

Now, the method for testing corrected vision is described.

(1) The electronic service center 1002 inputs uncorrected eye vision data on the homepage.

The uncorrected eye vision data includes:

Data that has been obtained through the vision test carried out on the network in the above-mentioned process of “the method for testing uncorrected eye vision”;

Prescription data of an ophthalmologist; and

Previous vision test data controlled at the electronic service center 1002.

(2) The electronic service center 1002 transmits an after-correction vision test window to the user interface unit 1001 and displays the window there. The window displays the Landolt ring that the user may recognize with lenses that are expected, according to the above-mentioned uncorrected eye vision input, to provide each of the eyes with corrected vision of 1.2. In other words, “a Landolt ring that would be seen as such” is displayed on the after-correction vision test window.

(3) The user interface unit 1001 allows the user to see the Landolt ring displayed on the window of the user interface unit 1001 with one uncorrected eye while covering the other eye, and thus determines how the user sees the Landolt ring of a level of magnification around 1.2.

(4) When the user can see the ring well at the user interface unit 1001 and clicks “seen well”, the electronic service center 1002 determines the level of magnification as the after-correction vision based on what has been transmitted from the user interface unit 1001.

When the user cannot see the ring well and clicks “not seen well”, the electronic service center 1002 determines that the user has an astigmatism based on what has been transmitted from the user interface unit 1001, and then the process proceeds to the step of performing an astigmatism test.

In the step of performing an astigmatism test, the electronic service center 1002 sends to the user interface unit 1001 a vision test table indicating four Landolt rings each of which has an opening at the top, bottom, and 90 degrees to the left and right. Then, the user can determine his or her astigmatism and its axis, based on how the user sees the Landolt ring on the after-correction vision test window transmitted to the user interface unit 1001. The points for determining the level of magnification in testing astigmatism are as follows:

(1) Rotating a Landolt ring slowly makes it possible to check whether or not there is a position at which the opening of the Landolt ring disappears. If there is such a position, the user at the user interface unit 1001 clicks at this point with a mouse on the after-correction vision test window. With the position clicked, the electronic service center 1002 identifies the astigmatic axis (AXIS).

If the same test repeated several times yields a variation, the electronic service center 1002 sends to the user interface unit 1001 an after-correction vision test window, to which a spherical level of magnification (SPH) has been added, and repeats the same test.

If the opening of the Landolt ring does not disappear, the user at the user interface unit 1001 clicks on “the opening does not disappear” on the after-correction vision test window, so that the electronic service center 1002 determines that the user has no astigmatism.

(2) In addition, the electronic service center 1002 transmits a radial index image to the user interface unit 1001. Then, the user interface unit 1001 allows the user to determine the positions of the most and least dark lines on the after-correction vision test window and click the positions with a mouse, thereby allowing the electronic service center 1002 to identify the astigmatic axis (AXIS).

(3) After the astigmatism has been identified, a vision test table showing a Landolt ring after correcting for the astigmatism is displayed on the window to check how it is seen.

(1) The vision corrected to a level of magnification 1.2 is determined as the corrected vision. The corrected vision is so set that the user can choose from “exactly corrected=1.2”, “roughly corrected=0.8”, and “moderately corrected=1.0”. Those who desire bifocal eyeglasses can take vision tests both for distance and for reading. For those who desire ready-made presbyopic eyeglasses, a level of magnification of presbyopia can be determined judging from their age. The system for determining levels of magnification in testing presbyopia is as follows.

(1) The user at the user interface unit 1001 inputs his or her age, occupation, use of eyeglasses, hobby, sport, present disease and so forth, on a questionnaire window transmitted from the electronic service center 1002 to the user interface unit 1001.

(2) Based on the user database of the electronic service center 1002, the level of magnification under the conditions described in (1) is determined in advance.

(3) By correlating (1) and (2), the applied level of magnification is determined.

Thus, for nearsightedness, data concerning the level of nearsightedness, the relationship between the level of nearsightedness and vision, and the type of nearsightedness (level of magnification) is extracted from the nearsightedness information database and displayed.

For farsightedness, data concerning the level of farsightedness and the type of farsightedness (level of magnification) is extracted from the farsightedness information database and displayed.

For astigmatism, data on the level of astigmatism, the relationship between the Landolt ring and level of magnification, and the relationship between Landolt ring and the astigmatism axis is extracted from the astigmatism information database.

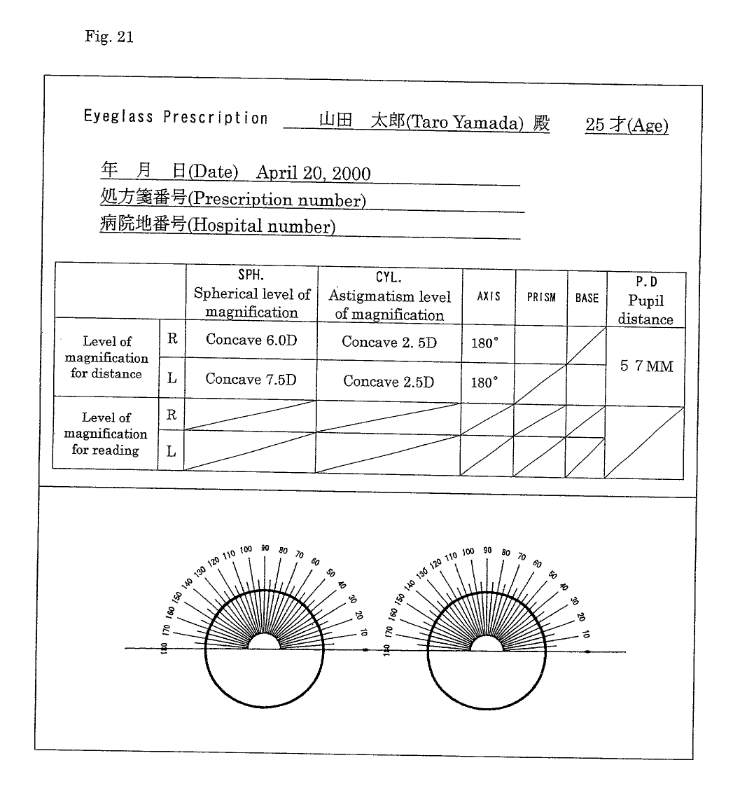

The results of vision test obtained at the electronic service center 1002 are transmitted to the user interface unit 1001 and displayed, for example, on a vision test result window as shown in FIG. 21.

DIST represents the level of magnification for distance and READ represents the level of magnification for reading.

SPH represents the spherical level of magnification, CYL represents the astigmatism level of magnification, AXIS represents the axis, and P.D. represents the distance from the center of the right eye to that of the left eye, that is, the pupil distance.

Incidentally, both levels of magnification for distance and reading are represented for the right eye (R) and the left eye (L).

According to this remote vision test system and the method therefor, anyone can have his or her uncorrected eye vision or after-correction vision tested easily and accurately via the Internet or other data transmission network.

The electronic service center 1002 may be integrated with the eyeglass ordering and marketing service center 2 to share the means having the same function for the remote vision test system to perform intensive processing. Alternatively, the electronic service center 1002 and the eyeglass ordering and marketing service center 2 may be adapted to perform distributed processing with a plurality of computers, servers, and other suitable elements.

The lens selection unit 26 of the eyeglass ordering and marketing service center 2 transmits a lens selection window for displaying lenses to the user interface unit 1. The lens selection window displays the lenses which are expected to comply with the user's request that the user has input at and sent from the user interface unit 1 and/or which the eyeglass ordering and marketing service center 2 recommends to the user. The lenses to be displayed on the lens selection window are chosen from various lenses registered in a database on the basis of the latest vision test data, doctor's prescriptions, and data obtained by the remote vision test system. If the user has been already registered, the lenses previously purchased are also displayed on the lens selection window.

The alternatives of the lenses include manufacture's names, models, intended use, lens functions (thickness and weight of lens, durability, prevention of UV light), colors, prices, and levels of magnification and so forth. The user chooses a lens that the user desires to buy, and then inputs on the lens selection window the one that the user desires to buy, which is in turn transmitted to the eyeglass ordering and marketing service center 2.

The eyeglass ordering and marketing service center 2 carries out the eyeglass ordering and marketing process using the lens selection unit 26, the eyeglass ordering and marketing processor 23, and the settling unit 24.

Now, the frame selection step will be described.

Suppose that data concerning the function and ornament of a frame exists at the eyeglass ordering and marketing service enter 2 such as in the case where the user has been already registered. In this case, the frame can be registered in terms of fashion, image, design and so forth.

Now, it is explained below how to select the frame in the case where data relating to the function and aesthetics of the frame exists at the eyeglass ordering and marketing service center 2.

Frames are registered as a database at the eyeglass ordering and marketing service center 2. A frame selection window for displaying typical frames chosen out of the database is transmitted by the frame selection unit 27 to the user interface unit 1.

Then, the user responds on the frame selection window to the inquiries in a questionnaire form including fashion, material, design, budget and so forth. Based on the data reflecting the user's requirements, the frame that is determined to be optimum is selected by the frame selection unit 27 in the eyeglass ordering and marketing service center 2. Then, the eyeglass ordering and marketing service center 2 sends the frame selection window to the user interface unit 1 again.

If the user has been already registered, the frame previously purchased is also displayed on the frame selection window.

The alternatives of the frame include fashion, material, design, price and other factors. The user selects a frame that the user desires to buy. Then, the user inputs the purchase of the frame that the user desires to buy on the frame selection window, which is in turn transmitted to the eyeglass ordering and marketing service center 2.

Now suppose that no data concerning the function of the frame exists in the eyeglass ordering and marketing service center 2 or the user desires to select a frame by having the frame, which the user wants to buy, put virtually on the face image of the user. In this case, the frame selection unit 27 instructs the user to proceed to a subsequent virtual eyeglass wearing experience step.

Now, the virtual eyeglass wearing system and the method therefor will be described.

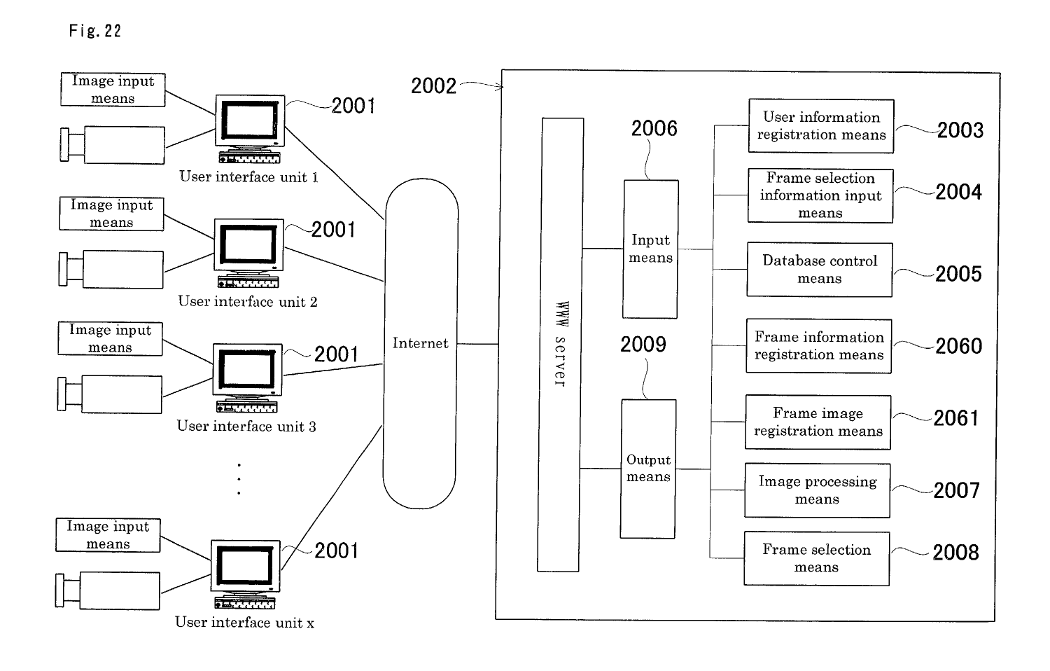

FIG. 22 shows a view illustrating an exemplary configuration of a virtual eyeglass wearing system.

The virtual eyeglass wearing system allows various types of eyeglass frames to be put on the image of user's face. The system includes a user interface unit 2001 and an electronic service center 2002.

These components are operatively connected to each other via a network. The following explanations will be made on the precondition that the Internet is preferably used as the network to connect the user interface unit 2001 to the electronic service center 2002. However, other data transmission systems may be used to connect these elements.

The user interface unit 2001 is a terminal used by a user for putting various types of eyeglass frames on the image of the user's face, being realized, for example, with a personal computer. The user interface unit 2001 preferably includes an I/O unit or an interface to a user using the I/O unit. More specifically, the user interface unit 2001 preferably includes input devices such as a keyboard or a mouse as well as output devices such as a CRT display. The user interface unit 2001 also has a WWW browser 2011 as an interface to the electronic service center 2002. When the user interface unit 2001 is a personal computer, the WWW browser 2011 is preferably realized as a program stored in the memory.

The electronic service center 2002 includes a user information registration unit 2003, a frame selection information input unit 2004, a database controller 2005, a frame information registration unit 2060, a frame image registration unit 2061, a frame selection unit 2008, an image processor 2007, an output unit 2009, and a server including a WWW server.

Specifically, information processing devices including personal computers, workstations, and a server or other suitable devices may be used. The electronic service center 2002 is preferably connected to the user interface unit 2001 via a wide area computer network (the Internet) or other suitable data transmission network.

The WWW server performs a function of building homepages that are used as an interface by the user interface unit 2001 to access the database controller 2005 and other elements.

The WWW server also has a user authentication unit to check a password and an identification (ID) of a user to determine if a user who requests registration to and browsing through a database from the user interface 2001 is authorized or not. The database is preferably controlled by the database controller 2005.

At the electronic service center 2002, an input unit 2006 including devices such as keyboards is used to input data concerning each frame provided by the electronic service center 2002. Then, text data concerning frame functional structures and frame ornamental structures is registered and controlled.

The frame image registration unit 2061 of the input unit 2006 at the electronic service center 2002 is used to input the image of frames that can be provided by the electronic service center 2002. Then, the frame images input at the electronic service center 2002 are registered and controlled.

The user information registration unit 2003 of the electronic service center 2002 is used to register and control user information such as face images transmitted from the user interface unit 2001.

The database controller 2005 stores and controls user's face images input by the user information registration unit 2003, and frame images input by the frame image registration unit 2061 of the input unit 2006.

The frame selection unit 2008 of the electronic service center 2002 is adapted to select a suitable frame functional structure, a frame ornament, and a frame image for each frame in the database controller 2005, which are stored by the frame information registration unit 2060. In this case, the selection is performed based on the frame selection references that are controlled by the database controller 2005, that is, functional structure data, ornamental structure data, and face image data for selecting a frame that the user desires. The frame selection unit 2008 is further adapted to create or select frame images for displaying some eyeglass frames of different types.

The image processor 2007 of the electronic service center 2002 is adapted to output an eyeglass wearing image in which an eyeglass frame image selected by the above-mentioned frame selection unit 2008 is combined with a face image data controlled by the database controller 2005.

The user interface unit 2001 preferably includes a terminal used by a user in applying for the virtual experience and is realized, for example, with a personal computer.

The user interface unit 2001 in this preferred embodiment preferably includes a personal computer as the main component and is further provided with a CRT or a head mounted display (HMD) as an image display unit capable of displaying view images. It is naturally possible to use other methods and devices for displaying images such as screen projection or laser irradiation. Moreover, a keyboard is preferably used as an information input device. However, it is possible to use various types of input devices such as pointing devices such as mice, track balls, or joysticks, touch panels, or switches or other suitable devices.

Furthermore, a digital camera is preferably provided as an image input device. However, any device such as television cameras, video cameras, or digital still cameras may be used so long as they allow image information to be digitized for input. In addition, a hard disc and a CD-ROM drive are prepared as a storage unit for storing images or other information, making it possible to use image information, programs or the like, which are stored in CDs. Naturally, it is also possible to use devices for storage media such as DVDs, MOs, or memory units. Furthermore, the personal computer according to this preferred embodiment is preferably adapted to be connected to the Internet or a computer network (network), so that image information, software, or the like can be transmitted and received via the network.

A computer that is a main component of the electronic service center 2002 first receives a command for operating the virtual eyeglass wearing system from a keyboard. The computer also includes the user information registration unit 2003 capable of receiving data such as personal information about users and display parameters of view images or a command for selection and the frame selection information input unit 2004. The computer further includes the frame image registration unit 2061 capable of receiving the input of image data digitized from a digital camera of the user interface unit 2001. The computer further includes the image processor 2007 that is capable of performing image processing according to the input data to select or form (create) an appropriate virtual eyeglass wearing image. Moreover, the computer is provided with the database controller 2005 that stores and controls software of the virtual eyeglass wearing system, image information, view image samples that can be selectively displayed, and so forth. View images that have been created or selected by the image processor 2007 are output from the output unit 2009 to be displayed on a CRT or HMD or other suitable display device of the user interface unit 2001.

Now, such a case is explained in which this system is implemented through a homepage or the like on a network such as the Internet (a wide area computer network).

First, the electronic service center 2002 uploads a homepage on the Internet with the WWW server. With an access device such as a WWW browser of the user interface unit 2001 connected to a wide area computer network, a user accesses the frame selection information input unit 2004 having an interface functioning as a homepage of the electronic service center 2002. Then, the user sends a request for registration of frame selection reference data.

The electronic service center 2002 allows the user authentication unit of the WWW server to verify that the user has been authorized and registered, based on the user authentication information such as the user's password and/or identification (ID) and other identifying information.

Subsequently, the frame selection information input unit 2004 of the electronic service center 2002 writes in a storage unit and controls the selection reference information that has been requested from the user for registration via the wide area computer network.

The electronic service center 2002 also transmits an input window of basic attributes of the user to the user interface unit 2001. On the user basic attribute input window transmitted to the user interface unit 2001, the user inputs basic attributes of the user such as the user's name, address, date of birth, telephone number, eye conditions (e.g., difficulty in viewing near distances), and requests for eyeglasses.

The user further inputs selection criteria for a frame such as sense of fashion, budget, function, condition of fit to the user's face into the user basic attribute input window sent from the electronic service center 2002.

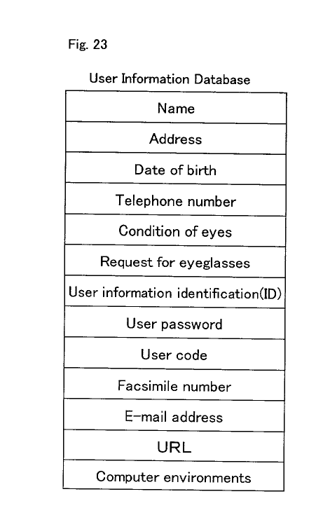

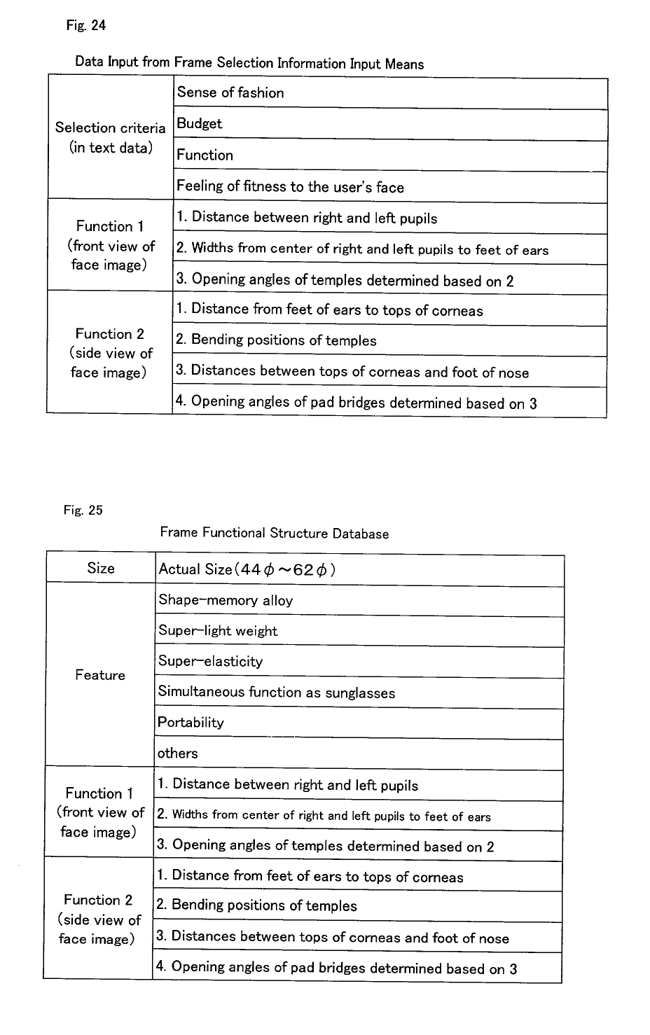

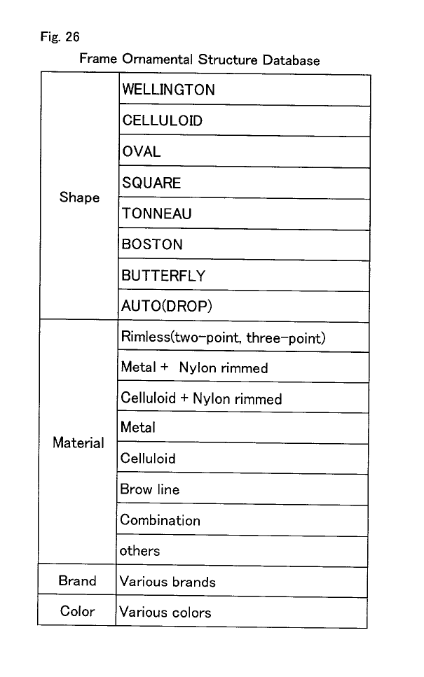

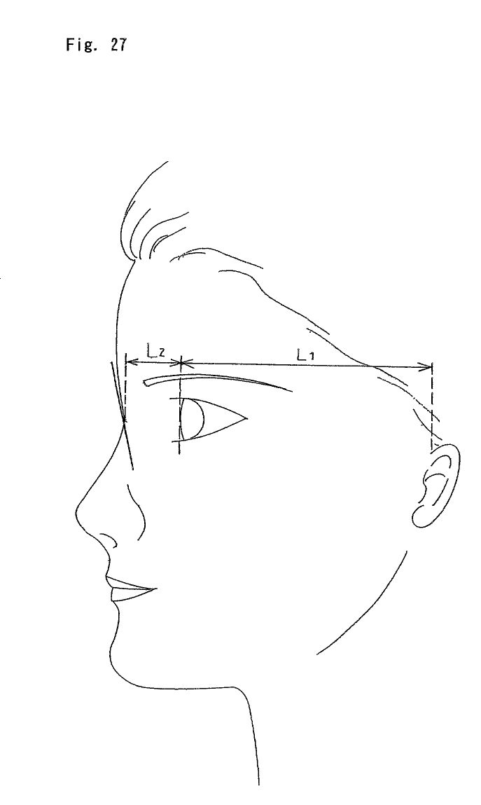

The electronic service center 2002 stores and registers the user's basic attributes, selection criteria for a frame and other suitable information, as shown in each database structure illustrated in FIGS. 23-26, controlled by the database controller 2005.

Face images input by an image input device of the user interface unit 2001 are also transmitted to the electronic service center 2002.

Incidentally, when a face image is input with the image input device, a ruler or other measuring device is placed under the face to allow the face image to be input in conjunction with the ruler.

Based on the front view and side views (both sides) of the face image sent to the electronic service center 2002, the electronic service center 2002 creates frame selection criteria.

That is, based on the text data and the image data transmitted from the user interface unit 2001, the frame selection information input unit 2004 of the electronic service center 2002 creates the functional structure data and ornamental structure data of a frame. Then, the database controller 2005 stores and controls the data in the storage unit.

The frame functional structure data includes, for example, the distance between the right and left pupils, the widths from the center of the right and left pupils to the feet of the ears, and the opening angles of temples determined based on the widths from the center of the right and left pupils to the feet of the ears. Also included are the distances from the feet of the ears to the tops of the corneas, the bending positions of the temples, the distances between the tops of the corneas and the foot of the nose, the opening angles of pad bridges determined based on the distances between the tops of the corneas and the foot of the nose, budgets and so forth.

Moreover, based mainly on text data such as selection criteria (sense of fashion and condition of fit to the face) transmitted from the user interface unit 2001, the frame selection information input unit of the electronic service center 2002 also creates frame ornamental structure data. Then, the frame ornamental structure data is stored in the storage unit and controlled by the database controller.

The frame ornamental structure data includes shapes such as Wellington, Celluloid, Oval, Square, Tonneau, Boston, Butterfly, and Auto (Drop). Materials are rimless (two-point, three-point), metal+nylon rimmed, celluloid+nylon rimmed, metal, celluloid, brow-line, combination and so forth. Brands include various brands, and colors include various colors.

At the electronic service center 2002, text data concerning the frame functional structure data and the frame ornamental structure data for each of the frames that can supplied is registered and controlled by the input unit 2006 such as a keyboard and the frame image registration unit 2061. The frame images input from the frame image registration unit 2061 of the input unit 2006 at the electronic service center 2002 are registered and controlled.

The frame functional structure data of each frame includes a size or an actual size (44F-62F), and features such as a shape-memory alloy, super-light weight, super-elasticity, simultaneous function as sunglasses, portability and so forth. Also included are functions such as the distance between the right and left pupils, the widths from the center of the right and left pupils to the feet of the ears, the opening angles of temples determined based on the widths from the center of the right and left pupils to the feet of the ears, the distances from the feet of the ears to the tops of the corneas, the bending positions of the temples, the distances between the tops of the corneas and the foot of the nose, and the opening angles of pad bridges determined based on the distances between the tops of the corneas and the foot of the nose.

The frame ornamental structure data includes shapes such as Wellington, Celluloid, Oval, Square, Tonneau, Boston, Butterfly, and Auto (Drop). Materials are rimless (two-point, three-point), metal+nylon rimmed, celluloid+nylon rimmed, metal, celluloid, brow-line, combination and so forth. Brands include various brands, and colors include various colors.

The user information registration unit 2003 of the electronic service center 2002 registers and controls face images transmitted from the user interface unit 2001. Frame images input from the frame image registration unit 2061 of the input unit 2006 at the electronic service center 2002 are registered and controlled.

The database controller 2005 stores user face images input by the user information registration unit 2003 and frame images input by the frame image registration unit 2061 of the input unit 2006.

The frame selection unit 2008 of the electronic service center 2002 is adapted to select a suitable frame functional structure, a frame ornament, and a frame image for each frame in the database controller 2005, which are stored by the frame information registration unit 2060. In this case, the selection is performed based on the frame selection references that are controlled by the database controller 2005, that is, functional structure data, ornamental structure data, and face image data for selecting a frame that the user desires. The frame selection unit 2008 is further adapted to create or select frame images for displaying some eyeglass frames of different types.

The image processor 2007 of the electronic service center 2002 is adapted to output an eyeglass wearing image in which an eyeglass frame image selected by the above-mentioned frame selection unit 2008 is combined with a face image data controlled by the database controller 2005.

Then, the eyeglass-wearing image combined by the image processor 2007 is adapted to be output to each user interface unit 2001 by the WWW server via the Internet.

Now, the method for the user to wear various eyeglasses using the above-mentioned virtual eyeglass wearing system is described below.

First, when the user interface unit 2001 is connected to the electronic service center 2002, an ID code input window or a user authentication window is transmitted.

The user authentication window prompts the user to input user authentication information.

At the user interface unit 2001, the user authentication window is received to be displayed, and then the user inputs user authentication information to be transmitted to the electronic service center 2002.

The user authentication information includes a password, user ID and other suitable identifying information.

The electronic service center 2002 receives the user authentication information, based on which the database controller 2005 and the user information registration unit 2003 retrieve in the user information database to perform authentication.

When it is determined at this time that the user is using the system for the first time, a window for inputting basic attributes is further transmitted from the electronic service center 2002 to the user interface unit 2001.

Based on the window transmitted from the electronic service center 2002, the user at the user interface unit 2001 inputs basic attributes of the user, such as the user name, address, date of birth, and telephone number.

The electronic service center 2002 receives the basic attributes of the user, based on which the database controller 2005 and the user information registration unit 2003 creates a user information database and registers the password, the user ID and so forth.

Then, the service center 2002 transmits a frame selection reference window for inputting frame selection criteria to the user interface unit 2001.

The frame selection reference input window is used by a user to input criteria (such as the sense of fashion, budget, function, sense of fitness to the face) for selecting a frame.

The user inputs frame selection criteria such as the sense of fashion, budget, function, condition of fit to the face and so forth on the frame selection reference input window at the user interface unit 2001.

Subsequently, after the user has completed inputting the frame selection criteria in text data, a window prompting the user to transmit the user face image is further transmitted from the electronic service center 2002 to the user interface unit 2001.

The user takes the front view and side views (right and left sides) of the user face image into the user interface unit 2001 with an image input device such as a digital camera or a scanner.

Then, the front and side views of the user face image are transmitted from the user interface unit 2001 to the electronic service center 2002 via the Internet.

The electronic service center 2002 allows the frame selection information input unit 2004 to receive the text data and image data (the face image of the user), which are frame selection criteria sent from the user interface unit 2001, and the database controller 2005 to register and control the data.

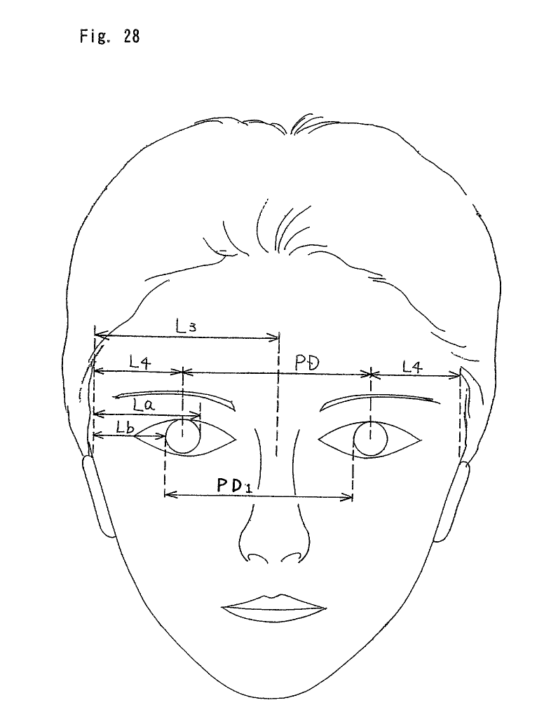

(1) Based on the side images (FIG. 27) of the user, the distances (L₁) between the feet of the ears and the tops of the corneas of the user are measured separately for the left and right, and the resulting data is registered and controlled by the database controller 2005. Based on the aforementioned measurements, the positions at which the temples are bent are determined separately for the left and right, and then registered.

(2) Based on the side images of the user, the distances (L₂) between the tops of the corneas of the user eyes and the foot of the nose are measured, and an average value of the left and right distances is registered and controlled in the database controller 2005. The distance L₂ is usually 12 mm. The frame selection information input unit 2004 determines and registers the opening angles of the pad bridges, based on the above measurements.

(3) Based on the front image (FIG. 28) of the user, the widths (L₃) from the center of the pupils of the right and left eyes to the feet of the ears are measured separately for the left and right, and are then registered and controlled by the database controller 2005. Based on the above measurements, the frame selection information input unit 2004 determines and registers the opening angles θ of the temples separately for the left and right.

For the widths from the center of the pupils of the right and left eyes to the ears, the distance between the pupils (PD) is first determined. However, at the electronic service center 2002, the pupils cannot be precisely detected on the user face image, and therefore the distance between the pupils (PD) is approximated, for example, from the distance (PD₁) between the left side of the left eye and the left side of the right eye.

The pupils cannot be detected from the face image. Therefore, to determine the distance (L₄) between the pupil of the left eye and the left ear, the distance from the foot of the left ear to the right side of the left eye (Lₐ) and the distance from the foot of the left ear to the left side (L_{b}) of the left eye are determined. Then, the distance (L₄) between the pupil of the left eye and the left ear is determined by calculation. The distance between the right eye and the right ear can also be determined in the same manner.

The opening angles θ of the left and right temples of the eyeglass frame are adjusted, for example, by correcting and bending the temples by the amount of angle obtained from the following equation.

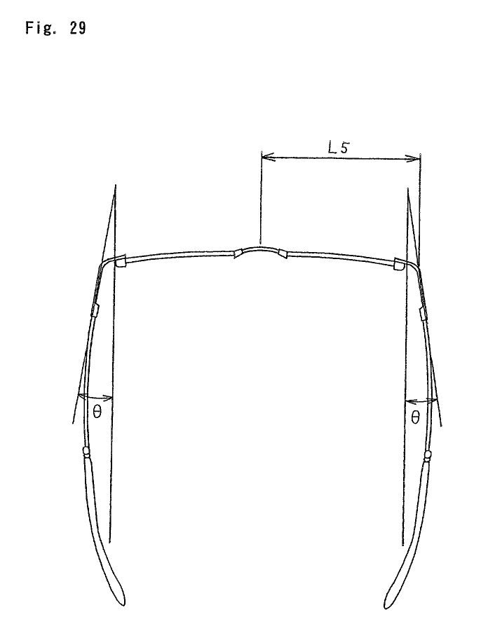

PD/2+L₄−L₅

where L₅ is the front size of the eyeglass frame (Refer to FIGS. 28 and 29).

(4) When bifocal lenses are specified, an additional bending angle of 5 degrees is provided for the angle of inclination of the lens surface. For this reason, the opening angle of the pad bridges is determined and registered by being corrected with the additional angle of bending.

Thus, at the service center 2002, the central processing unit and the frame selection information input unit 2004 perform computation to create functional structure data, ornamental structure data, and face image data, which are in turn stored by the database controller 2005 in conjunction with the face image data.

At the electronic service center 2002, the frame information registration unit 2060 and the frame image registration unit 2061 input and store in advance the frame functional structure, the frame ornamental structure, and the frame image of each frame in the database controller 2005. Based on the frame functional structure, the frame ornamental structure, and the frame image of each frame registered by the database controller 2005 through the frame information registration unit 2060 and the frame image registration unit 2061, an appropriate frame is selected corresponding to the functional structure data, ornamental structure data, and face image data according to the frame selection criteria transmitted from the user interface unit 2001.

The frame selection unit 2008 creates or selects frame images for displaying eyeglass frames of different types. Thereafter, the image processor 2007 of the electronic service center 2002 creates an eyeglass-wearing image in which the image of the frame that fits the face image of the user is combined with the face image of the user.

Then, the eyeglass-wearing image in which the face image of the user is combined with the frame image, which is created by the image processor 2007, is transmitted from the output unit 2009 (the WWW server) to the user interface unit 2001 via the Internet.

The user can check the image transmitted to the user interface unit 2001 to see if the frames agree with those that the user has requested and how the user's face looks like with the frames thereon at the eyeglass-wearing window.

Suppose that the frames are different from those that the user has requested or the user desires to see the face with different frames thereon. In this case, the user further inputs a message on this fact to the eyeglass wearing window sent from the electronic service center 2002 and transmits the message to the service center 2002.

On the other hand, the electronic service center 2002 selects different frames in the same manner as the one mentioned above, and again transmits an eyeglass-wearing window from the WWW server to the user interface unit 2001 via the Internet.

According to the virtual eyeglass wearing system and the method therefor, the user can put various eyeglass frames on photographic data. Moreover, the user can try on various eyeglass frames at home via a network such as the Internet without going out to an eyeglass shop and select optimum frames that meet the user's own preference.

The user cannot usually see his or her face with eyeglass frames thereon from a third person's point of view. However, according to this system and method, the user can select frames with the selected eyeglass frames on his or her face while the user wears his or her own eyeglasses or contact lenses, that is, with an adequate vision. Thus, the user can select eyeglass frames that best fit the user.

Incidentally, the electronic service center 1002 and 2002 maybe integrated into the eyeglass ordering and marketing service center 2, a single computer, and a server to perform processing. Alternatively, they may be adapted to perform distributed processing with a plurality of computers and servers.

According to the present invention, eyeglasses with levels of magnification that meet the vision and other requirements of each user can be ordered and marketed remotely by making use of a network.

While the preferred embodiments have been described, it is to be understood that modifications will be apparent to those skilled in the art without departing from the scope of the invention, which is to be determined solely by the following claims.

What is claimed is:

1. A network-based eyeglass lens and frame ordering and marketing system comprising:
a user interface unit;
an electronic service center;
at least one of a network and a data transmission system connecting the user interface unit and the electronic service center;
an eyeglass frame selection means for selecting eyeglass frames from among a plurality of eyeglass frames in response to input from a user;
means for creating display information relating to eyeglass frames;
vision testing means for testing vision of the user;
an eyeglass lens selection means for selecting eyeglass lenses from among a plurality of eyeglass lenses in response to user input;
an eyeglass ordering and marketing processing means for allowing said eyeglass frame selection means, said vision testing means, and said lens selection means to test vision in response to a requirement of the user sent from the user interface unit, to determine eyeglass frames and eyeglass lenses suitable for the vision tested by said vision testing means, for providing the user user with information about ordering, and for concluding an eyeglass purchase contract with the user; and
a display information creating means for creating information relating to eyeglass frames in cooperation with or independently of at least one of said frame selection means and said eyeglass ordering and marketing processing means, and for transmitting the information relating to the eyeglass frames to the user interface unit.

2. The system according to claim 1, wherein the electronic service center comprises an electronic shop information processing means, a display information creating means for creating display information such as electronic catalogs in response to a request from the user interface unit, a lens ordering processing means, a order settling means, and a WWW server.

3. The system according to claim 1, wherein said electronic service center comprises a user information registration means, a frame selection information input means, a database control means, a frame information registration means, a frame image registration means, a frame selection means, an image processing means, an output means, and a WWW server, said frame image registration means inputs frame images provided by the electronic service center, said user information registration means registers and controls user's information including a face image sent from the user interface unit, said database control means stores and controls user's face images input by the user information registration means and frame images input thereto, said frame selection means is adapted to select an appropriate one of frame functional structures, frame ornamental structures, and frame images, stored by the frame information registration means, for each frame of the database control means, corresponding to frame selection criteria requested by the user and controlled by the database control means, and is adapted to create or select a frame image for displaying eyeglass frames of different types, and said image processing means is adapted to output via an output means an eyeglass-wearing image with an eyeglass frame image, selected by said frame selection means, being combined with the face image data controlled by the database control means.

4. A network-based eyeglass lens and frame ordering system comprising:
a user interface unit;
an electronic service center;
at least one of a network and a data transmission system connecting the user interface unit and the electronic service center;
means for receiving data relating to vision of the user;
a lens selection means for selecting lenses from among a plurality of lenses based on the data relating to the user's vision received by the means for receiving data relating to vision of the user;
a lens ordering processing means for allowing said lens selection means to determine lenses satisfying requirements of the user sent from the user interface unit, for providing the user interface unit with information relating to ordering the lenses, and for concluding a lens purchase contract with the user; and
a display information creating means for allowing said lens ordering processing means to create information relating to lenses, and for transmitting the information relating to the lenses to the user interface unit.

5. The system according to claim 4, wherein said electronic service center comprises a user information registration means, a frame selection information input means, a database control means, a frame information registration means, a frame image registration means, a frame selection means, an image processing means, an output means, and a WWW server,
said frame image registration means inputs frame images provided by the electronic service center, said user information registration means registers and controls user's information including a face image sent from the user interface unit, said database control means stores and controls user's face images input by the user information registration means and frame images input thereto, said frame selection means is adapted to select an appropriate one of frame functional structures, frame ornamental structures, and frame images, stored by the frame information registration means, for each frame of the database control means, corresponding to frame selection criteria requested by the user and controlled by the database control means, and is adapted to create or select a frame image for displaying eyeglass frames of different types, and said image processing means is adapted to output via an output means an eyeglass-wearing image with an eyeglass frame image, selected by said frame selection means, being combined with the face image data controlled by the database control means.

6. A network-based eyeglass lens and frame ordering system comprising:
a user interface unit;
an electronic service center;
at least one of a network and a data transmission system connecting the user interface unit and the electronic service center;
a vision testing means for testing vision of a user;
a lens selection means for selecting lenses from among a plurality of lenses based on the data relating to the user's vision received by the means for receiving data relating to vision of the user;
a lens ordering processing means for allowing said vision testing means and said lens selection means to test vision in response to a requirement of the user sent from the user interface unit, for determining lenses suitable for the vision of the user, for providing the user interface unit with information about ordering, and for concluding a lens purchase contract with the user; and
a display information creating means for allowing said lens ordering processing means to create information relating to lenses, and for transmitting the information relating to the lenses to the user interface unit.

7. The system according to claim 6, wherein the electronic service center comprises an electronic shop information processing means, a display information creating means for creating display information such as electronic catalogs in response to a request from the user interface unit, a lens ordering processing means, a order settling means, and a WWW server.

8. A network-based eyeglass lens and frame ordering system comprising:
a user interface unit;
an electronic service center;
at least one of a network and a data transmission system connecting the user interface unit and the electronic service center;
a user information registration means for registering and controlling information of each user including a face image sent from the user interface;
a frame information registration means for storing and controlling user face images input by the user information registration means and frame images input by a frame image registration means;
a frame selection means for selecting frames from among frames stored in the frame information registration means based on frame selection criteria requested by the user and transmitted from the user interface unit in order to create an image of the selected frames;
means for combining the image of the eyeglass frames selected by said frame selection means with the user's face image data to output an eyeglass-wearing image; and
means for transmitting to the user interface unit the eyeglass-wearing image having the eyeglass frame image combined with the user's face image data.

9. The system according to claim 8, wherein the electronic service center comprises an electronic shop information processing means, a display information creating means for creating display information such as electronic catalogs in response to a request from the user interface unit, a lens ordering processing means, a order settling means, and a WWW server.

10. The system according to claim 8, further comprising:
an eyeglass frame selection means for selecting eyeglass frames from among a plurality of eyeglass frames in response to user input;
means for creating display information relating to eyeglass frames;
an eyeglass frame ordering processing means for allowing said eyeglass frame selection means to determine eyeglass frames satisfying requirements of the user sent from the user interface unit, for providing the user interface unit with information relating to ordering the frames, and for concluding an eyeglass frame purchase contract with the user; and
a display information creating means for allowing said eyeglass frame selection means to create information relating to eyeglass frames, and for transmitting the information relating to the eyeglass frames to the user interface unit.

11. The system according to claim 8, wherein said electronic service center comprises a user information registration means, a vision test information input means, a database control means, an image processing means, a vision data creation means, and a WWW (World Wide Web) server, and said user information registration means collects data about users or people requesting a vision test to register and control the data in a user information database, the data about users including addresses, names, dates of birth, telephone numbers, eye conditions, requirements for eyeglasses, and data for identifying users such as user identifications, user passwords, and user codes, said vision test information input means determines and registers a vision level, based on data concerning the vision test and including reference for carrying out the vision test with, the data being sent from the user interface unit, said image processing means registers and controls Landolt rings of a vision test table as a vision test table database, and transmits to the user interface unit and displays the Landolt rings of the vision test table registered and controlled in the vision test table database, and said vision data creation means retrieves vision test data including levels of nearsightedness, farsightedness, and astigmatism, based on the reference input from the user interface unit for the vision test, and creates vision test results including the retrieved and extracted data.

12. A method for ordering eyeglass lenses and frames via at least one of a network and a data transmission system and using a user interface unit, an electronic service center, and at least one of a network and a data transmission system connecting the user interface unit and the electronic service center, said method comprising:
selecting eyeglass frames from among a plurality of eyeglass frames in response to user input via the user interface unit;
creating display information relating to eyeglass frames;
testing vision of the user;
selecting eyeglass lenses from among a plurality of eyeglass lenses in response to the user input and the tested vision of the user;
processing an eyeglass order made based on said eyeglass frame selection step, said vision test step, and said lens selection step such that vision is tested vision in response to a requirement of the user sent from the user interface unit, determining eyeglass frames and eyeglass lenses suitable for the vision, providing the user interface unit with information about ordering, and concluding an eyeglass purchase contract with the user; and
creating display information relating to eyeglass frames in cooperation with or independently of one of said frame selection step and said eyeglass ordering processing step, and for transmitting the information on the eyeglass frames to the user interface unit.

13. A method for ordering eyeglass lenses and frames via at least one of a network and a data transmission system and using a user interface unit, an electronic service center, and at least one of a network and a data transmission system connecting the user interface unit and the electronic service center, said method comprising:
receiving data relating to vision of the user;
selecting lenses from among a plurality of lenses based on the data relating to the vision of the user;
a lens ordering processing step for determining lenses satisfying a requirement of the user sent from the user interface unit and said data relating to the vision of the user, for providing the user interface unit with information relating to ordering the lenses, and for concluding a lens purchase contract with the user; and
a display information creating step for creating information about the lenses in response to said lens ordering processing step, and for transmitting the information about the lenses to the user interface unit.

14. A method for ordering eyeglass lenses and frames via at least one of a network and a data transmission system and using a user interface unit, an electronic service center, and at least one of a network and a data transmission system connecting the user interface unit and the electronic service center, said method comprising:
testing vision of a user;
selecting lenses from among a plurality of lenses based on the tested vision of the user;
processing an order for a lens based on the tested vision in said vision test step and said lens selection step in response to requirements of the user sent from the user interface unit, for determining lenses suitable for the vision, for providing the user interface unit with information about ordering the lenses, and for concluding a lens purchase contract with the user; and
a display information creating step for creating information about the lenses in response to said lens ordering processing step, and for transmitting the information about the lenses to the user interface unit.

15. A method for ordering eyeglass lenses and frames via at least one of a network and a data transmission system and using a user interface unit, an electronic service center, and at least one of a network and a data transmission system connecting the user interface unit and the electronic service center, said method comprising:
registering and controlling user's information including a face image sent from the user interface unit;
a frame information registration step for storing and controlling user's face images input by the user information registration step and frame images input in a frame image registration step;
a frame selection step for selecting frames from among frames stored in the frame information registration step in response to frame selection criteria requested by the user and transmitted by the user interface unit, and for creating an image of the frames selected
a step for combining the image of the eyeglass frames selected in said frame selection step with the user's face image data, and for outputting an eyeglass-wearing image; and
a step for transmitting to the user interface unit the eyeglass-wearing image having the eyeglass frame image combined with the user's face image data.

16. The method according to claim 15, said method further comprising:
selecting eyeglass frames from among a plurality of eyeglass frames in response user input;
creating display information about eyeglass frames;
a step for allowing said eyeglass frame selection step to determine eyeglass frames satisfying a requirement of the user sent from the user interface unit, for providing the user user with information about ordering the frames, and for promoting the conclusion of an eyeglass purchase contract with the user; and
a display information creating step for creating information about eyeglass frames in response to said frame selection step, and for transmitting the information about the eyeglass frames to the user interface unit.
